(19) United States
(12) Patent Application Publication
(10) Pub. No.: US 2010/0097931 A1
(43) Pub. Date: Apr. 22, 2010

(54) MANAGEMENT OF PACKET FLOW IN A NETWORK

(76) Inventor: Shakeel Mustafa, Fremont, CA (US)

Correspondence Address: MURABITO, HAO & BARNES, LLP, TWO NORTH MARKET STREET, THIRD FLOOR, SAN JOSE, CA, 95113, US

(21) Appl. No.: 12/255,305

(22) Filed: Oct. 21, 2008

(51) Int. Cl. H04L 12/24

(52) U.S. Cl. 370/235

(57) ABSTRACT

Packets to be transmitted are received and stored by a first stand alone component. A packet sequencer may be generated and/or sequence number within packets may be used to track the transmitted packets of a given packet flow. Thus, packets may now be transmitted through different network paths. Transmitted packets are reassembled, by a second standalone component, in the order transmitted. A dropped packet may be identified and retransmission of the dropped packet requested. A copy of the dropped packet may be retransmitted from the first standalone component to the second without retransmitting the entire series of packets following the dropped packet. A confirmation packet by the second standalone component is generated to measure performance attributes of various network paths. The confirmation packet is used by the first standalone component to determine the next network path to be used to transmit the next packet in the given packet flow.

### BACKGROUND

Packet switching technologies are communication technologies that enable packets (discrete blocks of data) to be routed from a source node to destination node via network links. At each network node, packets may be queued or buffered, which may impact the rate of packet transmission. It should be appreciated that the experience of a packet as it is routed from its source node to its destination node affects quality of service (QoS).

Quality of service (QoS) refers to the ability to provide different priority to different applications, users, or data flows, or to guarantee a certain level of performance to a data flow. For example, a required bit rate, delay, jitter, packet dropping probability and/or bit error rate may be guaranteed. Quality of service guarantees are important if the network capacity is inadequate, especially for real-time streaming multimedia applications. For example, voice over IP, online games and IP-TV are time sensitive because such applications often require fixed bit rate and are delay sensitive. Additionally, such guarantees are important in networks where capacity is a limited resource, for example in networks that support cellular data communication.

QoS is sometimes used as a quality measure, rather than as a mechanism for reserving resources. It is appreciated that the experience of data packets as they move through a network from source node to destination node can provide the basis for QoS measurements.

FIG. 1 shows (Prior Art) conventional frame formats for packets which are used to transmit data in a network. A packet consists of two kinds of data: (1) control information and (2) user data (also known as a payload). The control information provides the data that the network needs to properly deliver the user data to the destination node. The control information includes source and destination addresses, error detection codes like checksums, and sequencing information, to name a few. Typically, control information is found in packet headers and trailers, with user data located therein between FIGS. 2-5 show (Prior Art) headers for IP version 4, TCP, UDP and RTP type packets respectively.

Conventional methods use the same transmission path, e.g., same network, regardless of the performance of the network. The same transmission path is used because the packets must be received in the sequence that they are sent in order to be reassembled correctly. Moreover, the same transmission path is used because the technology is currently incapable of determining the sequence of packets sent through various network paths. Thus, the packets must be sent through the same transmission path as dictated by the routing table.

Unfortunately, using the same transmission path to transmit packets regardless of the network performance such as delay, jitter, dropped packet, etc., of the transmission path is inefficient. For example, using the same transmission path regardless of the network performance may lead to using a network path with poor performance characteristics, e.g., congestion, delay, jitter, etc., even though better performing networks may be available.

Packets may be affected in many ways as they travel from their source node to their destination node that can result in: (1) dropped packets (e.g., packet loss), (2) delay, (3) jitter, and (4) out of order delivery. For example, a packet is dropped when a buffer is full upon receiving the packet. Moreover, packets may be dropped depending on the state of the network at a particular point in time, and it is not possible to determine what will happen in advance.

Unfortunately, conventional methods require retransmission of the lost packet as well as any subsequent packets that were transmitted. Thus, retransmission is not only inefficient but it introduces unnecessary and undesirable congestion and delay to the network.

A packet may be delayed in reaching its destination for many different reasons. For example, a packet may be held up by long queues. Excessive delay can render an application, such as VoIP or online gaming unusable. Jitter may also impact the network performance and is when packets from a source can reach a destination with different delays. A packet's delay can vary with its position in the queues of the routers located along the path between the source node and the destination node. Moreover, a packet's position in such queues may vary unpredictably. This variation in delay is known as jitter and may impact the quality of the application, e.g., streaming media.

Furthermore, conventional methods fail to provide a hierarchical priority for routing packets based on various criteria, e.g., destination address, source address, the type of application, the performance of the network, etc. In other words, packets cannot be prioritized and routed via different transmission paths based on various criteria. Thus, a quality of service cannot be guaranteed based on a priority and criteria set for each packet.

Conventional packet switching networks encounter many challenges as it relates to the management of packet flow through a network. Moreover, as discussed above, these challenges can severely affect quality of service (QoS) that is provided to network users. It is appreciated that conventional methods of addressing such challenges require significant overhead and do not provide optimal results. Accordingly, conventional methods of addressing the challenges presented in the management of packet flow through a network are inadequate.

### SUMMARY

Accordingly, a need has arisen to improve the flow of packet transmission in a network. In particular, a need has arisen to dynamically measure the network performance and route packets through different network paths based on the measured performance of networks and other criteria, e.g., priority of the packet, source address, destination address, application type, etc. Thus, a need has also arisen to determine the sequence of the received packets from different network paths in order to reassemble the received packets. Furthermore, a need has arisen to retransmit only the packet that has been dropped and not packets subsequent to the dropped packet. It will become apparent to those skilled in the art in view of the detailed description of the present invention that the embodiments of the present invention remedy the above mentioned needs.

Management of a packet flow in a network is disclosed. It is appreciated that a packet flow may be defined as any kind of flow, e.g., flow based on a source address, destination address, performance of the network, the type of the application, etc. According to one embodiment, packets to be transmitted are received by a first stand alone component. The first stand alone component stores a copy of the received packets and may generate a packet sequencer. The packet sequencer is based on the transmitted packets and enables out of sequence packets that are received to be reassembled by a second stand alone component. Thus, packets may now be transmitted through different network paths because the packet sequencer may be used to determine the order of the packets and reassemble the transmitted packets. In one embodiment, sequence numbers within the transmitted packet itself may be used to determine the sequence of packets, thereby eliminating the need for generation of a packet sequencer.

The second stand alone component that receives the packets along with a packet sequencer may store the received packets and may determine that a packet has been dropped. As such, retransmission of the dropped packet may be requested from the first stand alone component. Since a copy of the transmitted packets have been stored by the first stand alone component, the sender, e.g., a server, will not be burdened with retransmission. Moreover, since a copy of all packets are stored by the first stand alone component, only the dropped packet may be retransmitted without a need to retransmit the entire series of packets following the dropped packet. As such, network congestion, network delay and etc. are reduced that improves the packet flow. The entire packets that have been transmitted may be reassembled based on the packet sequencer by the second stand alone component. Alternatively, the sequence numbers within the packets may be used to reassemble the received packets, thereby eliminating the need to use the packet sequencer.

A confirmation packet may be generated by the second stand alone component for a received packet. The confirmation packet in addition to acknowledging the receipt of the packet may identify and measure various parameters related to performance of the network path. For example, the confirmation packet may identify the delay, jitter, number of dropped packets, bit error rate, etc. As such, the measured performance parameters of the network may be used by the first stand alone component to determine the appropriate network path to be used to transmit the next packet within that flow. As such, a quality of service and packet flow within a network is improved.

### BRIEF DESCRIPTION OF THE DRAWINGS

The accompanying drawings, which are incorporated in and form a part of this specification, illustrate embodiments and, together with the description, serve to explain the principles of the embodiments:

FIG. 1 shows conventional frame formats for packets which are formatted blocks of data.

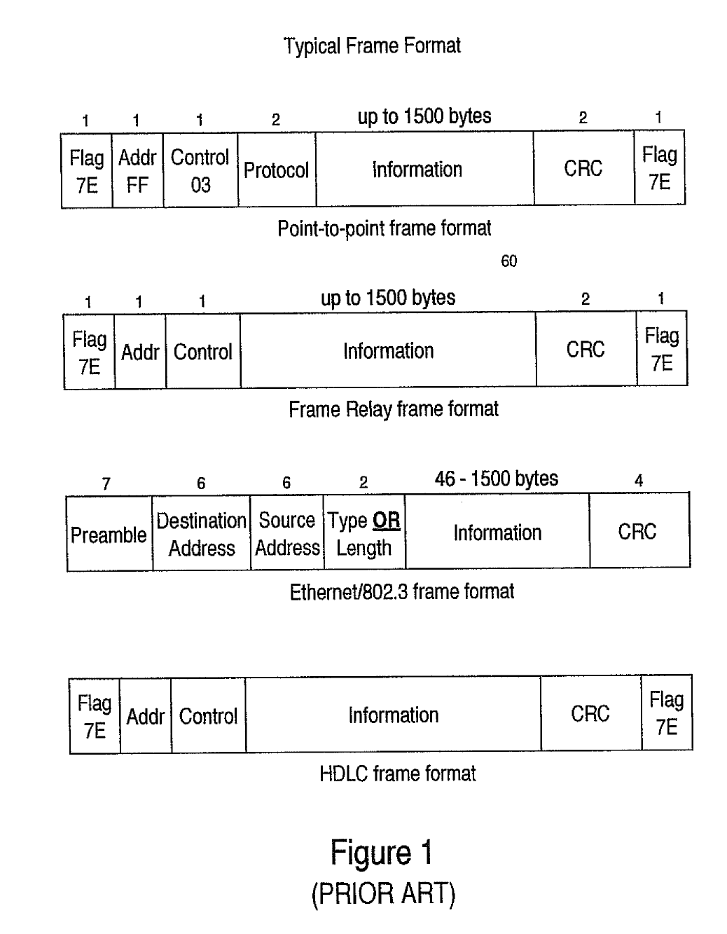

FIG. 2 shows components of a conventional IP version 4 type packet.

FIG. 3 shows components of a conventional TCP type data packet.

FIG. 4 shows components of a conventional UDP type data packet.

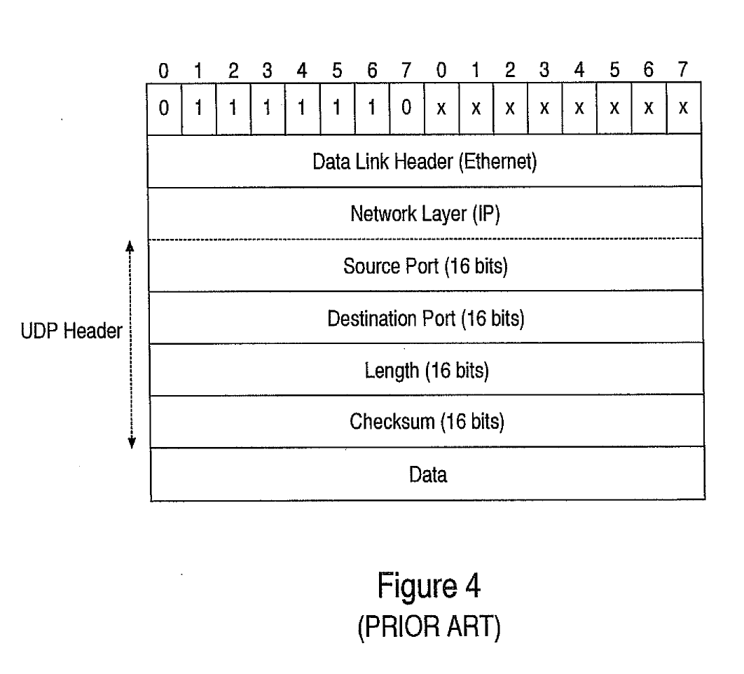

FIG. 5 shows components of a conventional RTP type data packet.

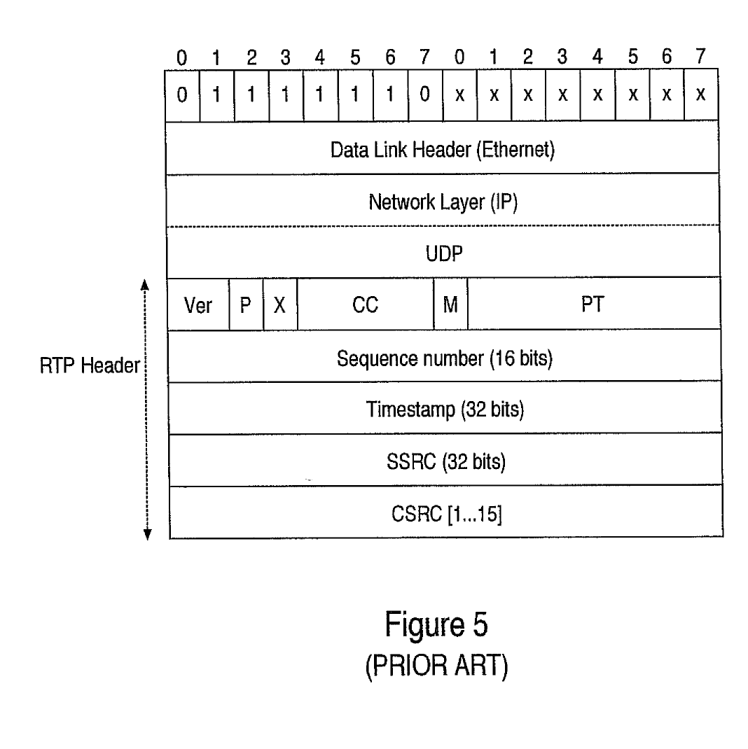

FIG. 6A shows an exemplary system for managing packet flow according to one embodiment of the present invention.

FIG. 6B shows an exemplary standalone component for managing packet flow according to one embodiment of the present invention.

FIG. 6C illustrates configuring a standalone component for management of packet flow according to one embodiment of the present invention.

FIG. 6D shows an exemplary structure of a configuration packet according to one embodiment of the present invention.

FIG. 6E shows an exemplary graphical user interface (GUI) for prioritizing packet flow in accordance with one embodiment of the present invention.

FIG. 7A shows identification of packet type frame in accordance with one embodiment of the present invention.

FIG. 7B shows accessing a setup routine for collection and analysis of data for a selected flow in accordance with one embodiment of the present invention.

FIG. 7C illustrates execution of the setup routines to collect and analyze performance data according to one embodiment of the present invention.

FIG. 7D illustrates identifying a data collection address, operant criteria, read value and routine address according to one embodiment of the present invention.

FIG. 7E illustrates accessing instructions for a routine for collecting data according to one embodiment of the present invention.

FIG. 7F shows a data storage space system that supports QoS parameters according to one embodiment of the present invention.

FIG. 8 shows features of an incoming packet according to one embodiment of the present invention.

FIG. 9A shows generation of a packet flow ID in accordance with one embodiment of the present invention.

FIG. 9B illustrates avoiding packet flow collisions according to one embodiment of the present invention.

FIG. 10 shows generation of packet flow ID based on the type of data according to another embodiment of the present invention.

FIG. 11 illustrates generation of a packet and flow identifiers w according to one embodiment of the present invention.

FIG. 12 illustrates storing a packet according to one embodiment of the present invention.

FIG. 13 shows a confirmation packet according to one embodiment of the present invention.

FIG. 14 shows identifying packets within a packet flow that are within a predetermined delay range according to one embodiment of the present invention.

FIG. 15 illustrates tracking transmitted packets according to one embodiment of the present invention.

FIG. 16 shows comparison of a sequence of confirmation packets with the transmitted packet table to identify missing packets according to one embodiment of the present invention.

FIG. 17A illustrates identifying sequence packet according to one embodiment of the present invention.

FIG. 17B illustrates retransmission of dropped packets according to one embodiment of the present invention.

FIG. 17C shows an exemplary format of a confirmation packet according to one embodiment of the present invention.

FIG. 17D illustrates re-sequencing out of order packets according to one embodiment of the present invention.

FIG. 17E illustrates out of order sequence packets according to one embodiment of the present invention.

FIG. 17F shows re-ordering out of sequence packets according to one embodiment of the present invention.

FIG. 17G illustrates decoding of the sequence number to identify a corresponding address in a re-sequencing buffer according to one embodiment of the present invention.

FIG. 17H illustrates disabling addresses that do not contain data according to one embodiment of the present invention.

FIG. 18A illustrates a confirmation packet for identifying missing packets in accordance with one embodiment of the present invention.

FIG. 18B illustrates compilation of a bulk packet according to one embodiment of the present invention.

FIG. 18C shows identifying the number of dropped packets in accordance with one embodiment of the present invention.

FIG. 18D shows identifying the number of packets within a predetermined jitter range according to one embodiment of the present invention.

FIG. 18E shows identifying the number of packets within a predetermined range of displacement from their original transmission order according to one embodiment of the present invention.

FIG. 18F illustrates clearing a shared memory buffer according to one embodiment of the present invention.

FIG. 19 shows components of a system for management of packet flow according to one embodiment of the present invention.

FIG. 20 shows an exemplary method for management of packet flow according to one embodiment of the present invention.

FIG. 21 shows an exemplary method of transmitting a confirmation packet according to one embodiment of the present invention.

FIG. 22 shows a continuation of the exemplary method of FIG. 21.

FIG. 23 shows an exemplary method of packet re-sequencing on a per flow basis according to one embodiment of the present invention.

FIG. 24 shows an exemplary method of packet re-sequencing on a per flow basis for handling data packet according to one embodiment of the present invention.

FIG. 25 shows a continuation of the exemplary method of FIG. 24.

FIG. 26 shows a continuation of the exemplary method of FIG. 25.

FIG. 27 shows an exemplary method of retransmission of lost packets based on a routine for confirmation packet according to one embodiment of the present invention.

FIG. 28 shows an exemplary method of retransmission of lost packets based on transmission table according to one embodiment of the present invention.

FIG. 29 shows a continuation of the exemplary method of FIG. 28.

FIG. 30 shows an exemplary method of re-sequencing packets for transmission according to one embodiment of the present invention.

FIG. 31 shows an exemplary method of managing packet flow in accordance with one embodiment of the present invention.

FIG. 32 shows an exemplary computing device according to one embodiment of the present invention.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description, numerous specific details are set forth in order to provide a thorough understanding of embodiments. In other instances, well-known methods, procedures, components, and circuits have not been described in detail as not to unnecessarily obscure aspects of embodiments.

### Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “creating” or “transferring” or “executing” or “determining” or “instructing” or “issuing” or “receiving” or “tracking” or “transmitting” or “setting” or “incrementing” or “generating” or “storing” or “re-transmitting” or “identifying” or “re-assembling” or “sending” or “sequencing” or “halting” or “clearing” or “accessing” or “aggregating” or “obtaining” or “selecting” or “calculating” or “measuring” or “displaying” or “accessing” or “allowing” or “grouping” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary System for Management of Packet Flow in a Network

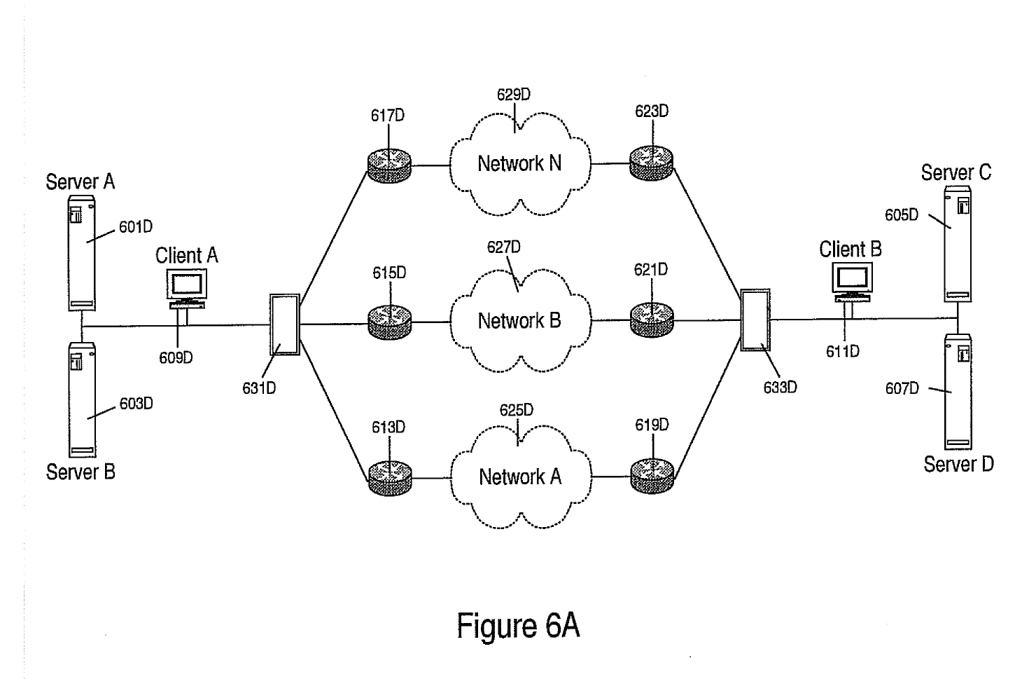

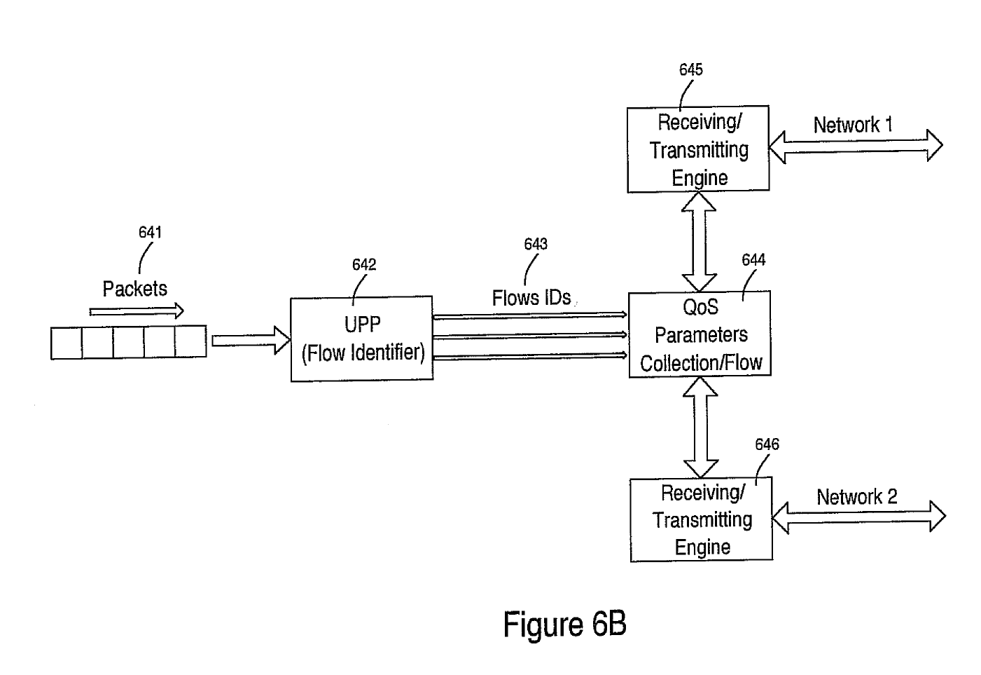

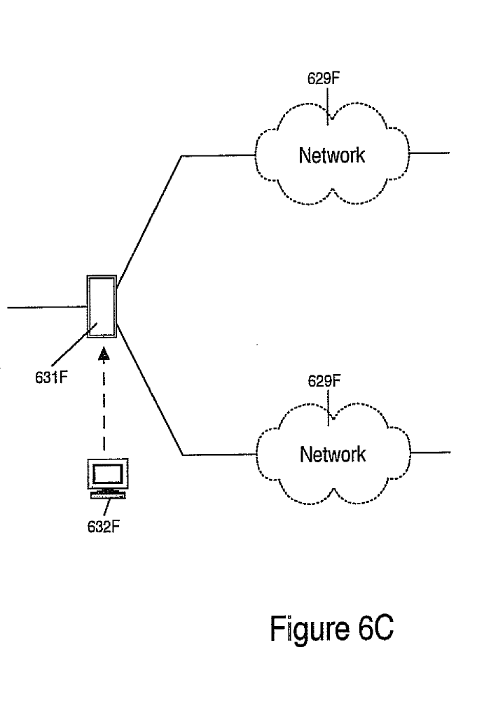

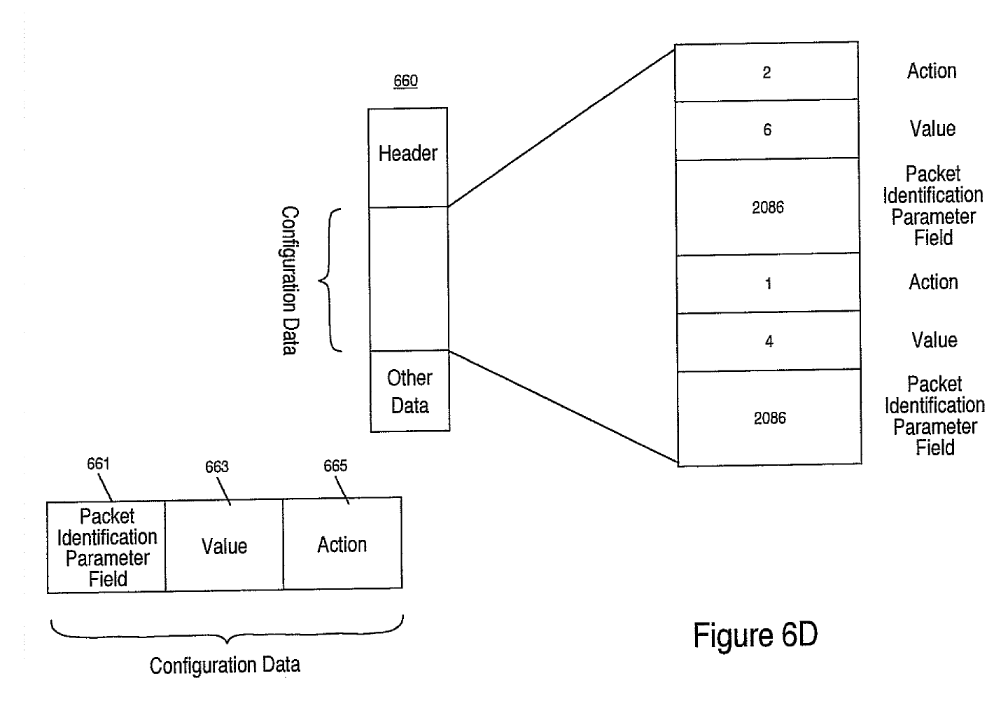

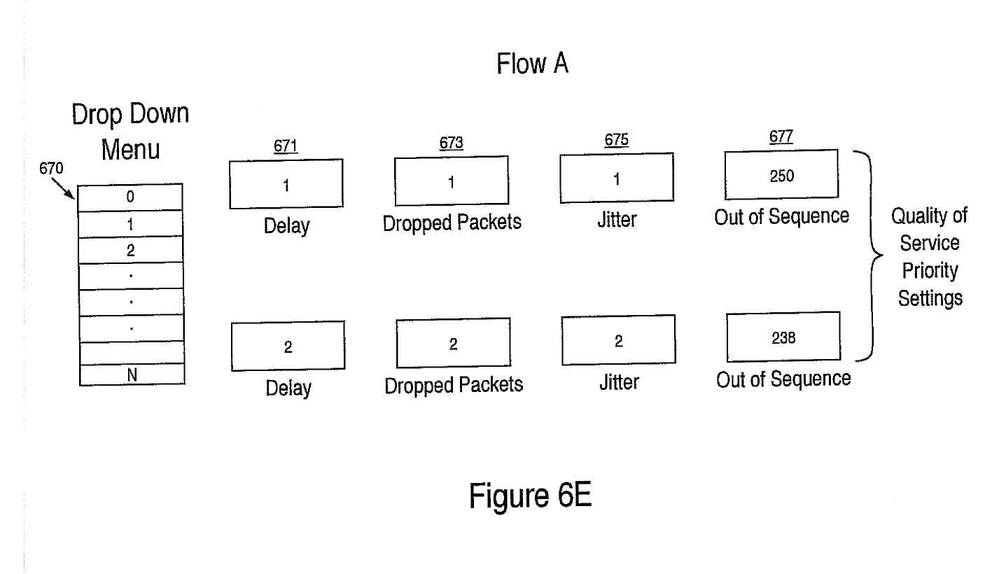

Referring to FIG. 6A, an exemplary system for managing packet flow in accordance with one embodiment of the present invention is shown. The exemplary system includes two standalone components 631D and 633D that manage packet flow in accordance with embodiments of the present invention. A packet flow may be any kind of flow for a given packet. For example, a packet flow may be defined by identifying the source address, the destination address, the type of application, priority of the packet, etc., or any combination thereof. In other words, a packet flow may be defined by any portion or any combination of the packet field, e.g., identification, protocol ID, version, header, checksum, etc. Accordingly, a packet flow is dynamically defined based on any kind of criteria and in any desired granularity.

In one embodiment the two standalone components 631D and 633D enable transmission of packets via different network paths independent from a routing table. The transmission of packets between the two standalone components 631D and 633D may be based on the defined packet flows, performance of network paths and user defined priorities of packet flows. As such, packets within a given packet flow may be transmitted via different network paths, received out of sequence and still be able to successfully reassemble them, once received, in order to improve the flow of packets.

In response to received packets, a confirmation packet may be generated by a packet receiving standalone component. The confirmation packet may measure the performance of the network path, e.g., jitter, dropped packet, delay, etc., that was used for transmission of the received packets. The confirmation packet may be sent to the transmitting standalone component to enable the sending standalone component to dynamically determine and select an appropriate network path to be used for transmitting the next packet that belongs to the defined packet flow. Thus, the packet flow is improved.

It is appreciated that a dropped packet may be identified. However, only the dropped packet needs to be retransmitted whereas in the conventional system the dropped packet and subsequent packets were required to be re-transmitted. Packets following the dropped packets are no longer retransmitted because out of sequence packets can now be reassembled successfully, thereby eliminating the need to retransmit all the packets following the dropped packet.

Referring still to FIG. 6A, the system 600A includes a server A 601D, server B 603D, server C 605D, server D 607D, client A 609D, client B 611D, switch A 613D, switch B 615D, switch C 617D, switch D 619D, switch E 621D, switch F 623D, network A 625D, network B 627D, network N 629D, standalone component 631D and standalone component 633D. According to one embodiment, the standalone component 631D may receive a packet or a plurality of packets from client A 609D. The received packet may be a request to establish a connection between client A 609D and client B 611D. It is appreciated that the connection may be established between any two components, e.g., server A 601D and client B 611D, server C 605 D and server B 603D, etc. As such, receiving a request to connect client A 609D to client B 611D is exemplary and not intended to limit the scope of the present invention.

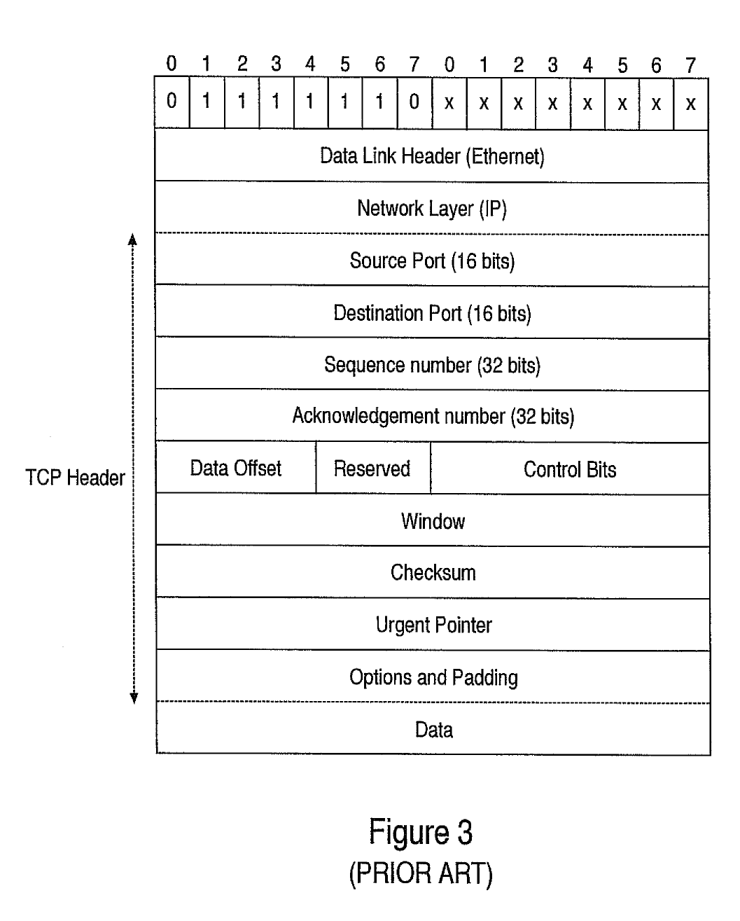

After establishing a connection, the standalone components 631D and 633D may use an embedded sequence number in certain header fields of packets within a given packet flow for transmission over a given established connection to provide a mechanism for tracking the correct sequence of packets transmitted and received. For example, the TCP header containing 32 bit sequence (see FIG. 3), acknowledgement field and/or 16 bit sequence number of the RTP header may be used. Accordingly, tracking the sequence number enables the standalone components 631D and 633D to transmit packets out of sequence and the receiving standalone component still be able to reassemble the received packets that are out of sequence.

It is appreciated that according to one embodiment, the standalone components 631D and 633D may generate a packet sequencer. The packet sequencer generated by one standalone component, e.g., the standalone component 631D, enables the other standalone component, e.g., the standalone component 633D, to reassemble out of sequence packets without using the sequence number in the TCP header. Generation of a packet sequence is described later.

After establishing a connection, the standalone component 631D receives packets from client A 609D. The standalone component 631D assigns a sequence number, as discussed above, and/or generates a packet sequencer for the received packets. In one embodiment, the standalone component 631D stores a copy of the received packets prior to their transmission to the standalone component 633D. Packets may be transmitted from the standalone component 631D to the standalone component 633D based on the defined packet flow, as described above, e.g., based on source address, destination address, the type of application, etc. Accordingly, packets may be sent from the standalone component 631D to the standalone component 633D via different network paths, e.g., network N 629D, 627D, 625D, etc.

It is appreciated that packets may be transmitted from the standalone component 631D via different network paths even though they may belong to the same packet flow. For example, one packet may be transmitted via the network A 625D path while another packet may be transmitted via the network N 629D path. In contrast, the conventional method sends packets only through the same network path as specified by the routing table.

The standalone component 633D receives the transmitted packets from the standalone components 631D via various network paths, e.g., network A 625D, network B 627D, network N 629D, etc. The standalone component 633D may store the received packets. It is appreciated that the received packets are out of sequence because each network path may perform differently, e.g., delay, jitter, etc., and thus ordered packets that were transmitted are received out of sequence.

The standalone component 633D may reassemble the transmitted packets by using either the packet sequencer that was generated and transmitted by the standalone component 631D and/or by using the sequence number within the TCP or RTP header, for instance. It is appreciated that TCP header or RTP header may be given as an exemplary embodiment throughout this application. However, any field within the packets may be used, e.g., acknowledgment field. Thus, the TCP and RTP header for tracking the sequence number are exemplary and not intended to limit the scope of the present invention. When the received packets are reassembled in the order transmitted, the standalone component 633D may determine that a packet has been dropped. The standalone component 633D may request retransmission of the dropped packet only from the standalone component 631D.

The dropped packet and not packets subsequent to the dropped packet, is being retransmitted by the standalone component 631D to the standalone component 633D. Only the dropped packet is retransmitted because a copy of the received packets is stored by the standalone component 633D and the sequence number and/or the sequence generator packet may be used to reassemble the already received packets along with the dropped packet. Accordingly, the packet flow is improved.

According to one embodiment of the present invention, for received packets and/or for each received packet, a confirmation packet may be generated by the receiving standalone component. For example, the standalone component 633D may generate a confirmation packet for each of the received packets or generate a confirmation packet for a plurality of received packets. The confirmation packet may acknowledge the receipt of the packets. In one embodiment, the confirmation packet contains information that may be used to measure various parameters of network paths performance for a given packet flow. For example, the confirmation packet may measure performance of network A 625D for a packet transmitted via network A 625D and measure performance of network N 629D for a packet transmitted via network N 629D. The network performance parameters may include the number of dropped packets for a packet flow within a given network path, the jitter of a packet flow within a given network path, the delay of a packet flow within a given network path, etc. The method by which the confirmation packet measures the performance of a network path is described later.

According to one embodiment, the confirmation packet may be sent via the same network path that the packet was received and/or the shortest and the most reliable network path. For example, the confirmation packet is transmitted via network B 627D if the packet is received from the network B 627D or it may be transmitted via network path A, for instance. The standalone component 631D receives confirmation packets and can therefore determine the network performance of various network paths for a given packet flow.

The received performance parameter may be compiled into a list and used statistically. For example, as additional information regarding the performance of a given network path becomes available the list may be updated. The performance parameters may be used by the standalone component 631D to determine an appropriate network path to be used in transmitting the next packet of a given packet flow. For example, the network path parameters may determine that network A 625D is less congested, has fewer delays and minimal jitter. Thus, the standalone component 631D may determine that a packet that belongs to a given packet flow identified as time sensitive, e.g., a VOIP application, may be transmitted via network A 625D because of fewer delays and minimal jitter. As such, the performance of the network may be used in conjunction with a defined packet flow and acceptable threshold to determine an appropriate network path for improving the packet flow. It is appreciated that the acceptable threshold may be user definable, e.g., network administrator, using a graphical user interface (GUI).

It is appreciated that conversely, a packet flow that belongs to a given packet flow identified as an application that is not time sensitive, e.g., an Email application, may be transmitted via a network path other than network A 625D. Moreover, it is appreciated that the packet flow may be defined by a network administrator in any manner. For example, a packet flow may be defined by the source address of the packet or by the destination address of the packet or by any field within the packet or any portion of the field or any combination thereof.

The packet flow may be defined using a graphical user interface (GUI) and a prescribed action may be defined to dynamically change the behavior of the network, e.g., network path to be used. In other words, a particular action may be defined by the network administrator based on the performance of various network paths, the defined packet flow, priorities of the packet flow and acceptable threshold for the packet flow. It is further appreciated that defining a prescribed action based on performance of network paths, the defined packet flow, priorities of packet flows and acceptable performance threshold for packet flows is made possible because packets can be received out of sequence and still be reassembled successfully. As such, monitoring the condition and performance of network paths that can vary over time and selecting an appropriate network path to transmit subsequent packets based on a defined packet flow and their priorities improves the flow of packet.

Referring to FIG. 6B, an exemplary standalone component for managing packet flow in accordance with one embodiment of the present invention is shown. Packets 641 are received. A UPP 642 component may identify the flow ID 643 of the received packet. For example, a packet flow as defined by a network administrator may be given a flow ID and be retrieved by the UPP 642 component. In one embodiment, the UPP 642 component may include multiple state machine algorithms that may identify an IP layer based signature that uniquely identifies the packet and a unique flow ID that the packets belong to.

The flow IDs 643 may be transmitted to a QoS parameter measurement engine 644. In one embodiment, the QoS parameter measurement engine 644 may use the performance of network paths to determine an appropriate network path to be used for transmission of subsequent packets within the identified packet flow. In other words, QoS parameter measurement engine 644 collects data related to QoS parameters of individual flows (e.g., performance of networks). Based on the collected information, QoS parameter measurement engine 644 determines that appropriate network path for transmitting subsequent packets within the identified packet flow. It is appreciated that receiving/transmitting engines 645 and 646 may be used to send and receive packets.

Referring to FIG. 6C, configuring a standalone component for management of packet flow according one embodiment of the present invention is shown. A configuration agent 632F may be used. The configuration agent 632F may comprise a graphical user interface (GUI) such that a packet flow can be defined. Similarly, the GUI may be used to define an acceptable threshold for the performance of various network paths. Also, the GUI may be used to prioritize packet flows based on various criteria, e.g., attributes of network performance such as delay, jitter, out of sequence packets, dropped packets, etc.

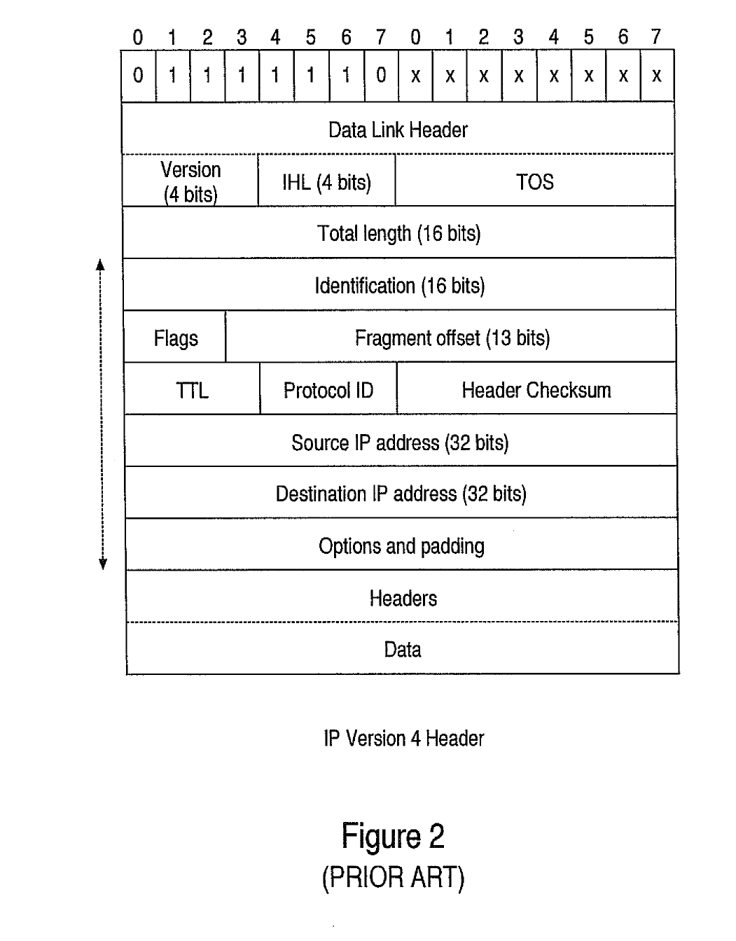

It is appreciated that in one embodiment, a network administrator may select any known criteria within packet fields in order to define a packet flow as described above. A packet flow ID may be assigned. As such, a particular action may be prescribed for a packet belonging to a given packet flow and further based on a measured performance of a given network path. For example, the network administrator may define a first flow for packets with the IP version 4 (see FIG. 2) and a second flow for packets with the IP version 6. The prescribed action may be to transmit all packets belonging to the first packet flow, hence IP version 4, via a network with less delay and to transmit all packets belonging to the second packet flow, hence IP version 4, via a network path with less jitter. Thus, a prescribed action is performed based on the type of flow as dynamically defined by the network administrator.

Referring now to FIG. 6D, an exemplary structure of a configuration packet in accordance with one embodiment of the present invention is shown. In one embodiment, the prescribed command from the network administrator can be communicated via a configuration packet. In one embodiment, configuration packet 660 may include a packet identification parameter field 661, a value field 663 and an action field 665. The packet identification parameter field 661 designates the type of packets that are to be selected. In other words, the packet identification parameter field 661 identifies packets within a given packet flow.

The value field 663 may designate the sub-group of the type of packets that are to be selected. As such, the value field 663 may further define the packets within a given packet flow. For example, a packet flow may be defined to identify all packets that are IP version 4. The value field 663 may further define the packet flow to be packets that are IP version 4 but that originate from a given source address, packets that are for a given type of application, etc. In other words, the value field 663 provides granularity to the defined packet flow.

The action field 665 may define the type of action to be taken with regard to the identified packets. For example, the action may be to send the identified packet via a network path with minimal delay. In the exemplary configuration the packet identification parameter may be 2086 that identifies IP packets. The packet flow for an IP packet may be further narrowed down to identify packets that correspond to IP version 6 type. Thus, the value may be 6 that corresponds to IP packets version 6 type. The action value may be set to 2 that identifies the prescribed action to be transmission of IP packets of version 6 type over network path 2. Similarly, another packet flow may be identified as IP packets by the packet identification parameter field of 2086. The value field, e.g., 4, may further define a packet flow to be packets corresponding to IP packets version 4 type. The action, e.g., 1, may indicate that packet flows corresponding to IP packets of version 4 should be transmitted via the first network path.

Referring now to FIG. 6E, a GUI for prioritizing packet flows in accordance with one embodiment of the present invention is shown. The configuration agent 632 may assign priorities to respective packet flows based on the quality of service parameters, e.g., delay, packet loss, jitter, out of sequence packets etc., and the measured performance of the network path. As such, the assignment of priorities may be used along with the measured performance of various network paths to determine which network path to be used to transmit the next packet that belongs to a given packet flow.

For example, an administrator may select a priority value from a drop down menu 670 for each of the quality of service parameters 671-677 for each of the defined packet flows. According to one embodiment, once a priority value is selected for a quality of service parameter, the selected priority value may not be selected for a different packet flow. In one embodiment, the granularity of priority values may range from 0 to 4000+. For example, for a packet flow A with quality of service priority settings of 1 for delay, 1 for packet loss, 1 for jitter and 250 for out of sequence packets may be selected. In contrast, a packet flow B with quality of service priority settings of 2 for delay, 2 for packet loss, 2 for jitter and 238 for out of sequence packets may be selected. Thus, in a contest between packet flows A and B, the packet from packet flow A may be forwarded over the best performing network for delay, packet loss and jitter. On the other hand the packet from packet flow B may be forwarded over the best performing network for out of sequence packets.

It is appreciated that since various priorities may be assigned to various packet flows, packet flows defined by the type of application, e.g., VOIP, Email, etc., may be given different priorities based on the desired QoS. For example, the administrator can assign a higher priority to the delay performance of a given network path for packets associated with VOIP applications in comparison to an e-mail application. Thus, packets for VOIP may be transmitted before packets for the Email application. Thus, the flow of packet based on various criteria, e.g., application type, destination address, source address, etc., is improved and may be dynamically changed by the network administrator.

In one embodiment, the management of a packet flow in a network involves the identification of the type of packet frame as a basis for the determination of performance characteristics such as network delay, packet drop rate, jitter, and out of sequence packets. For example, the type of packet frame may be a point to point frame format, frame relay format, Ethernet format, HDLC format, etc.

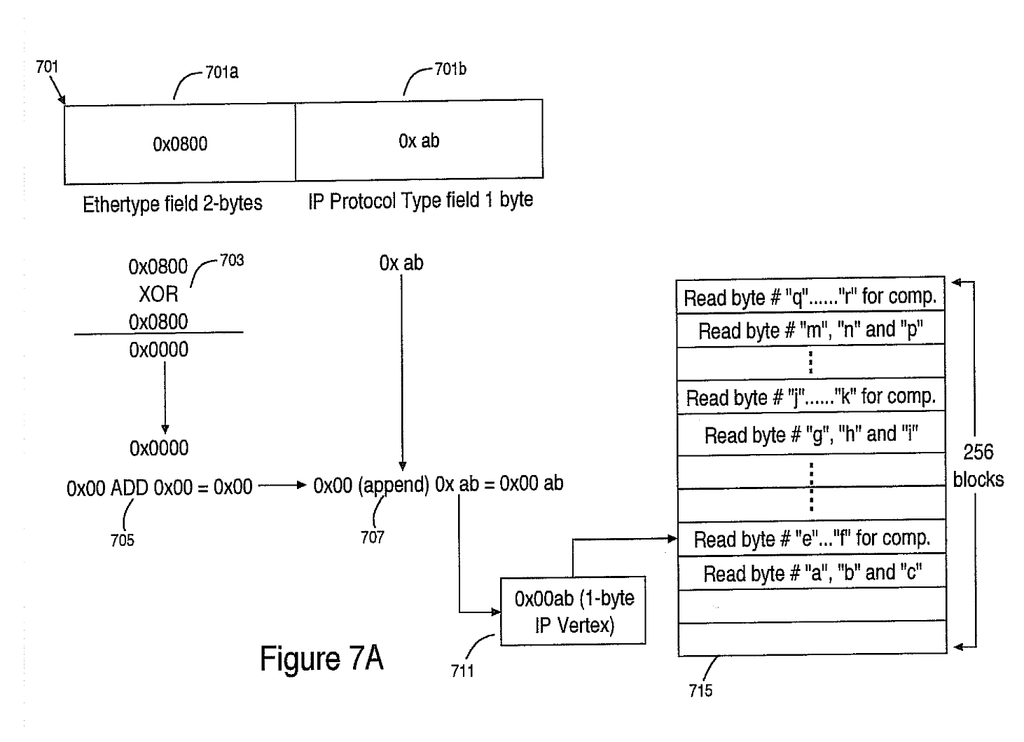

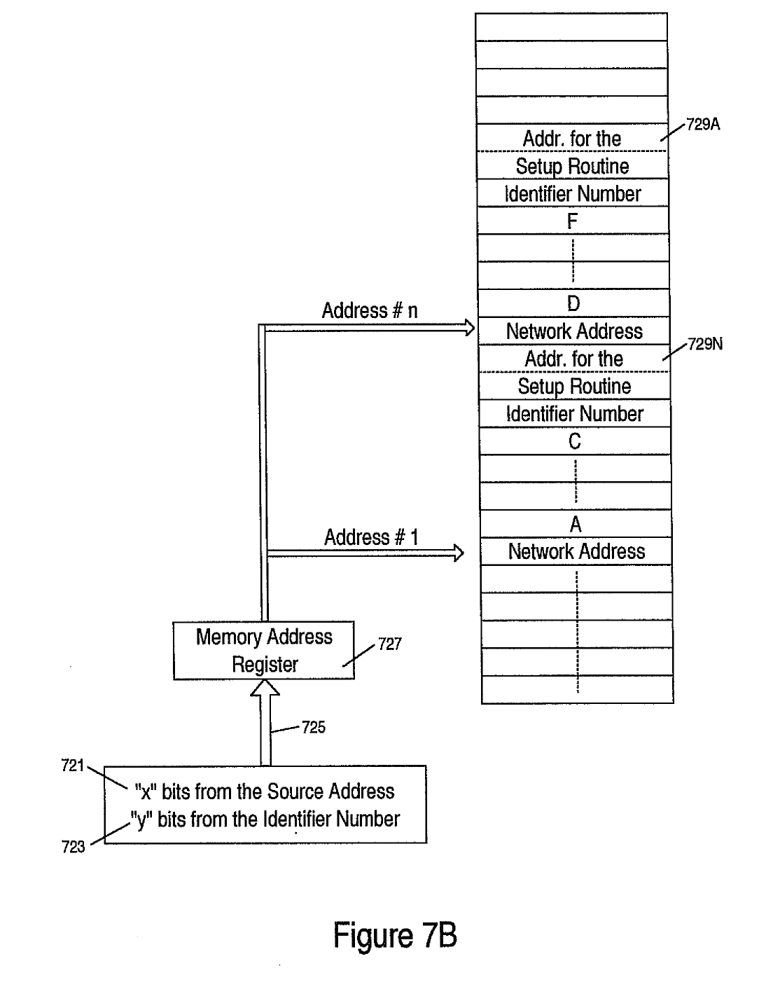

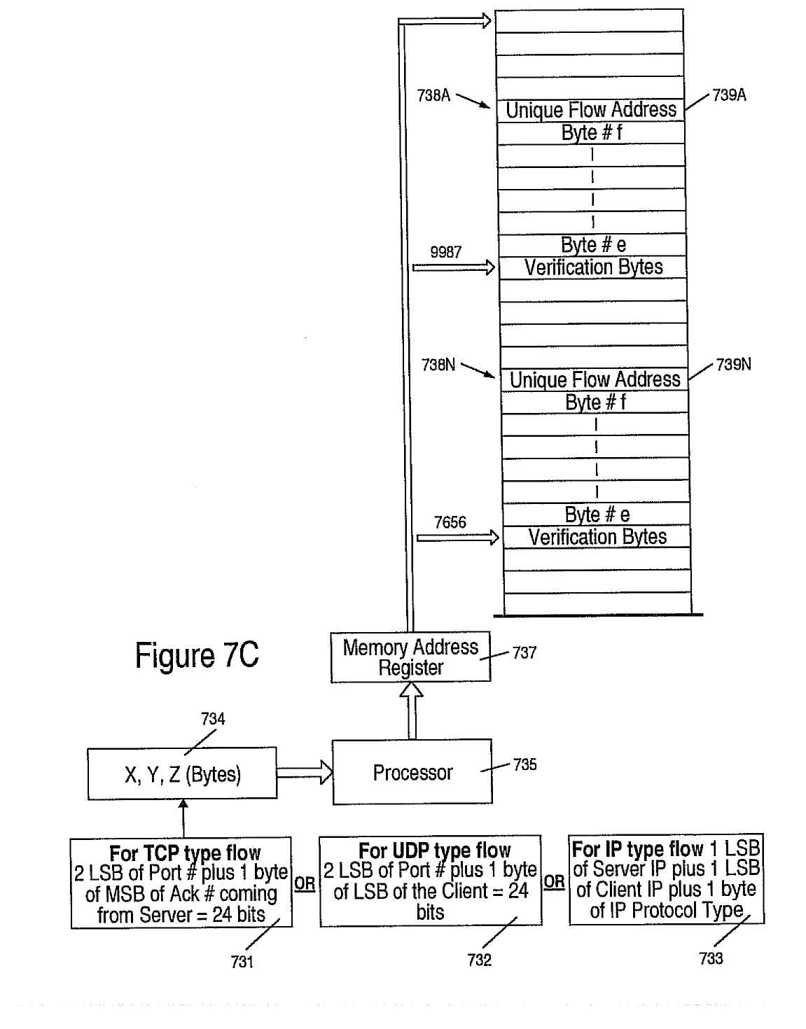

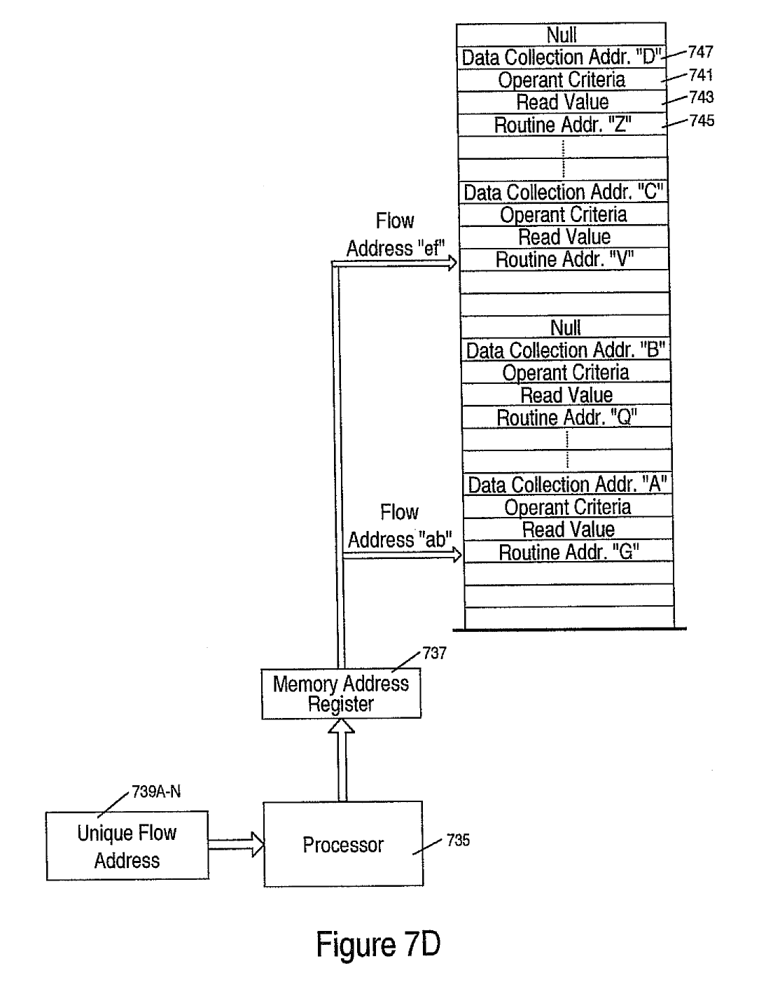

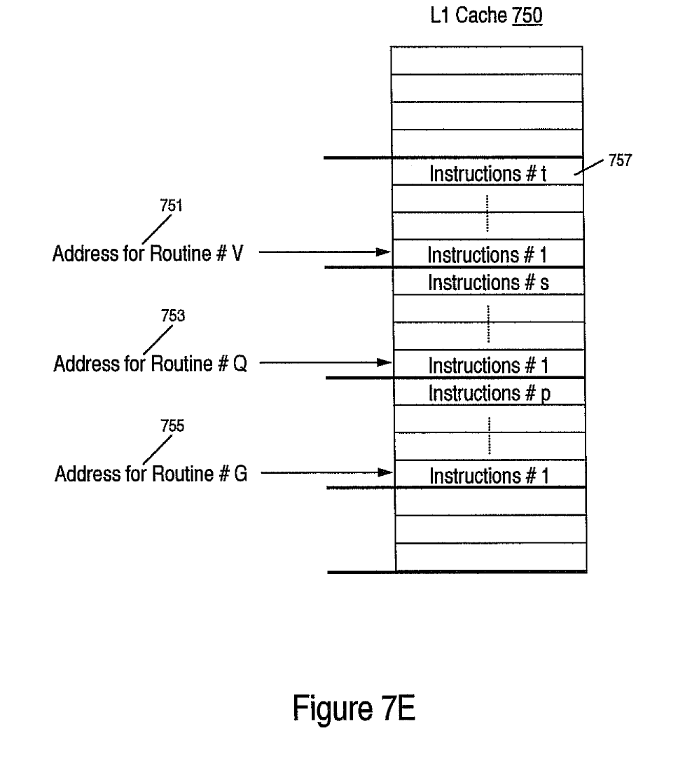

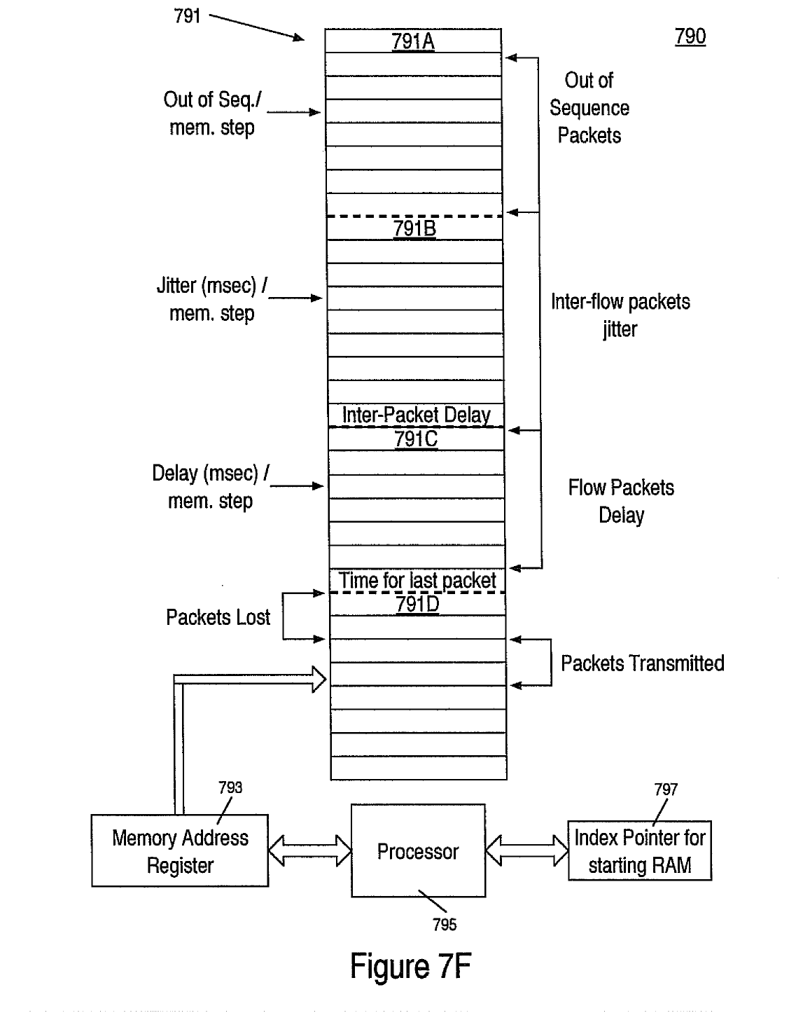

Referring now to FIG. 7A, identification of packet type frame in accordance with one embodiment of the present invention is shown. Identification of the type of packet is premised on the presumption that the majority of the packets are IP packets with Ethernet format. Thus, a fast method of identifying whether the packet is an IP packet is developed. A conventional method may be used to determine the type of the packet frame when the packet is not an IP packet.

In one embodiment of the present invention, it is assumed that the incoming packet 701 is an IP packet with an Ethernet packet format. As such, it is presumed that the incoming packet 701 includes ethertype field 701A and IP protocol type field 701B. In order to check the validity of this presumption, an exclusive OR (XOR) is performed between the value of the ethertype field 701A and the presumptive value for IP packet format that has a value of 0800. If the value of the ethertype field 701A is 0800, the XOR 703 operation results in all zeros indicating that the presumption that the incoming packet 701 has an IP packet format is correct.

The XOR 703 is used because XOR 703 requires less clock cycles to compute in comparison to an “if” statement, for instance. If the result of the XOR 703 operation is anything but 0000, then the presumption that the incoming packet 701 is an IP packet is incorrect, at which stage a conventional method may be used to determine the format of the incoming packet 701. It is appreciated that since the majority of the time the packets are of IP format, the overall saving in computational clock cycles outweighs the computational clock cycles even if the presumption is not correct every time.

Once it is determined that the presumption is correct, the first byte of the ethertype field 701a is operationally added 705 to the second byte of the ethertype field 701a resulting in a one byte field of 00 that is operationally appended 707 to the IP protocol type field 701b, e.g., ab value. The IP protocol type field 701b may be used to identify a particular packet flow and its prescribed action. Appending a one byte 00 with the one byte of the IP protocol type field is a two byte value result with 256 possibilities. The 256 possibilities may be stored in a cache, thereby improving the speed by which the packet flow is identified and its prescribed action is obtained.

The result of the appending operation 707 is sent to an IP vertex 711 and thereafter to the verification instruction storage block 715. Thus, the result of the “exclusive or” operation (four bits of such) 0x00 is provided with the appendage 0xab in order to determine an IP vertex resulting in an IP vertex of 0x00ab. A system and method for executing pattern matching is described in a provisional patent application No. 61/054,632 with attorney docket number NCEEP001R, inventor Shakeel Mustafa, entitled “A System and Method for Executing Pattern Matching” that was filed on May 20, 2008 and assigned to the same assignee. The instant patent application claims the benefit and priority to the above-cited provisional patent application and the above-cited provisional patent application is incorporated herein in its entirety.

The IP vertex is an input to memory access register 715 that may be the verification instruction storage. The instructions stored in the memory access register 715 may locate instructions that direct the reading of particular bytes based on the flow type. In one exemplary embodiment, the instructions stored therein may be used to form a storage address identifier to locate data, e.g., unique flow address, for facilitating the collection and analysis of data.

It is appreciated that when the presumption is not true, hence the packet is not an IP packet, the storage address identifier may cause the access of a storage address that does not contain the aforementioned information. In other words, a memory location outside of the 256 block of possibilities is accessed, utilizing a slower process, to facilitate the collection and analysis of data. As such, a packet identifier may be accessed from the UPP 642, as described in FIG. 6B, to access a setup routine for establishing a unique flow address. The unique flow address may be used to facilitate the collection and analysis of data related to the selected flows as shown in FIG. 7B.

Referring now to FIG. 7B, accessing a setup routine for collection and analysis of data for a selected flow in accordance with one embodiment of the present invention is shown. FIG. 7B, illustrates an exemplary embodiment for identifying a packet flow based on a source and destination addresses. In one embodiment, a storage address identifier may be formed from an identifier number and a source address. It is appreciated that the identifier number may be provided by an associated UPP 642.

According to one embodiment, a predetermined number “X” 721 bits from the source address is identified. Furthermore, a predetermined number of bits “Y” 723 from the identifier number is identified. The predetermined number “X” bits 721 and the “Y” bits 723 may be used to access a setup routine address storage identifier 725. For example, the predetermined “X” bits 721 and the “Y” bits 723 may be combined in one exemplary embodiment, resulting in the setup routine address storage identifier 725.

In other words, a certain portion of the source and/or destination addresses may be chosen and fed to the memory address register 727. As a result address corresponding to the memory location 722 is identified. It is appreciated that the selected number of bits may be fewer bits than the entire bits representing the source and the destination network address. The complete or the partial Network bytes 729M may be stored in order to maintain a one to one correspondence between the accessed memory, the source and the destination address. According to one embodiment, the processor may compare the stored bytes 729M with the source and destination network address in order to verify the one to one correspondence between the pair and the location where they are stored.

The setup routine address identifier 725 may be used in a memory address register 727 to identify one or more memory addresses that contain a setup routine. For example, using the setup routine address identifier 725 in the memory address register 727 may identify memory addresses 729A-729N that contains the setup routines. It is appreciated that the setup routines may correspond to a selected packet flow. According to one embodiment, the execution of the setup routine establishes a unique flow address. In one exemplary embodiment, the execution of the setup routines may cause a performance data to be collected in a routine address to facilitate the collection and analysis of data related a selected packet flow.

Referring now to FIG. 7C, execution of the setup routines to collect and analyze performance data in accordance with one embodiment of the present invention is shown. An address identifier may be used to access a unique flow address, as presented above. The unique flow address may provide access to information such as performance data collection routine address, data collection addresses, etc.

Different fields and portions of a packet may be used in order to obtain an address identifier 734. The fields and portions of the packet to be used may be based on the type of the packet, e.g., TCP, UDP, IP, etc. For example, in a TCP packet type of flow 731, the address identifier 734 may be the least two significant bytes of the port number plus the most significant byte of the acknowledgment number.

It is appreciated that to obtain an address identifier 734 for a UDP packet a different portion and fields of the packet may be used. For example, in a UDP packet type, the two least significant bytes of port number plus the least significant byte of the client may be used. In contrast, in an IP packet, the least significant byte of the server IP plus the least significant byte of the client IP address plus one byte of IP protocol may be used. However, it is appreciated that other combinations and/or portions and fields may be used and the use of the specific portions and fields described herein are exemplary and not intended to limit the scope of the present invention.

The address identifier 734 may be used by a processor 735 to access a memory address register 737. As a result a memory address 738A-738N may be accessed. The memory addresses 738A-738N may contain a unique flow address 739A-739N that correspond to a specific packet flow.

According to one embodiment, initially it is assumed that the packet, upon which the operation is based, is a part of an existing packet flow that has been selected for analysis. However if the accessed memory address is empty, it can be concluded that the packet is not part of an existing packet flow. Thus, as discussed above with reference to FIG. 7B, the packet identifier may be obtained from the UPP to facilitate the access of a setup routine. Accordingly, the setup routine may be used to establish a unique flow address for the new packet flow.

Referring to FIG. 7D, identifying a data collection address, operand criteria, read values and routine address in accordance with one embodiment of the present invention is shown. The unique flow address 739A-739N as described with respect to FIG. 7C is obtained. As such, the processor 735 may provide this data to memory address register 737. A memory address is accessed based on the flow address that is provided to memory address register 737. The memory address may contain operand criteria 741, e.g., IP packets, a read value 743, e.g., IP version 4 type packet, IP version 6 type packet, a performance data collection routine 745 and a data collection address 747.

It is appreciated that the content of the memory address described above is exemplary and not intended to limit the scope of the present invention. According to one embodiment, the operand criteria 741 and the read value 743 may be provided to the routine in the routine address 745. The output of the routine may be stored in the memory address 747.

Referring now to FIG. 7E, accessing instructions belonging to a routine for collecting data in accordance with one embodiment of the present invention is shown. The address of one or more routines, e.g., dropped packet data collection routine, delay routine, jitter routine, etc., is accessed based on the routines identified by the processes as described in FIG. 7D. For example, address for routine V 751, address for routine Q 753, address for routine G 755, etc., may be accessed to measure a selected performance with respect to a selected packet flow.

According to one embodiment, instructions such as instruction 757 for collecting data that is a part of the routine may be executed. According to one embodiment, the routines are stored and accessed from L1 cache 750, thereby reducing the access time in comparison to a the access time of a remote memory, e.g., RAM, hard disk, etc.

Referring now to FIG. 7F, a data storage space system for supporting QoS parameters in accordance with one embodiment of the present invention is shown. A memory storage space system 790 may include storage space 791, memory address register 793, processor 795 and index pointer for starting RAM 797. According to one embodiment, the storage space 791 includes storage space for out of sequence packet data 791A, storage space for packet delay data 791B, storage space for inter-flow packet jitter data 791C, and storage space for packets transmitted data 791D. It is appreciated that other performance parameters may also be stored in the storage space 791 and the parameters described above are exemplary and not intended to limit the scope of the present invention.

According to one embodiment, the index pointer for starting RAM 797 determines the location for storing data in the data storage space 791. In one exemplary embodiment, subsequently related data may be stored in adjacent address. For example, the first data to be stored for a packet jitter may be stored in a first location and a subsequent packet jitter may be stored in a second location of the storage space 791. The first location is adjacent to the second location both of which are within the inter-flow packets jitter section of the storage space 791.

The information stored within the storage space 791 may be utilized to analyze QoS parameters, e.g., out of sequence packets, delay, jitter, dropped packets, etc. For example, the data stored in storage space 791 may be provided to a data analysis system for generating performance analysis result such as, graphs of the performance of a network with regard to QoS parameters, e.g., delay, out of sequence packets, jitter, dropped packets, etc., or any combination thereof.

It is appreciated that the routines and data involved in the data collection and analysis as described with respect to FIGS. 7A-7H may be accessed directly without the use of such nested pointers. Thus, the use of the nested pointers is exemplary and not intended to limit the scope of the present invention.

It is further appreciated that the collected data within the data storage space 791 may be transferred to a different portion of the system. For example, the collected data may be transferred to a data query system, e.g., SQL database, such that various fields and customer identifier can be searched. As a result of transferring the collected data to a different portion, the collection blocks may be cleared to make room for new data to be collected. It is appreciated that the transferring of data may be time range dependent or based on a user defined criteria. For example, the system may automatically detect when the blocks within the data storage space 791 is becoming full and cause the collected data to be transferred to a different location such that the data storage space 791 can continue collection of new data.

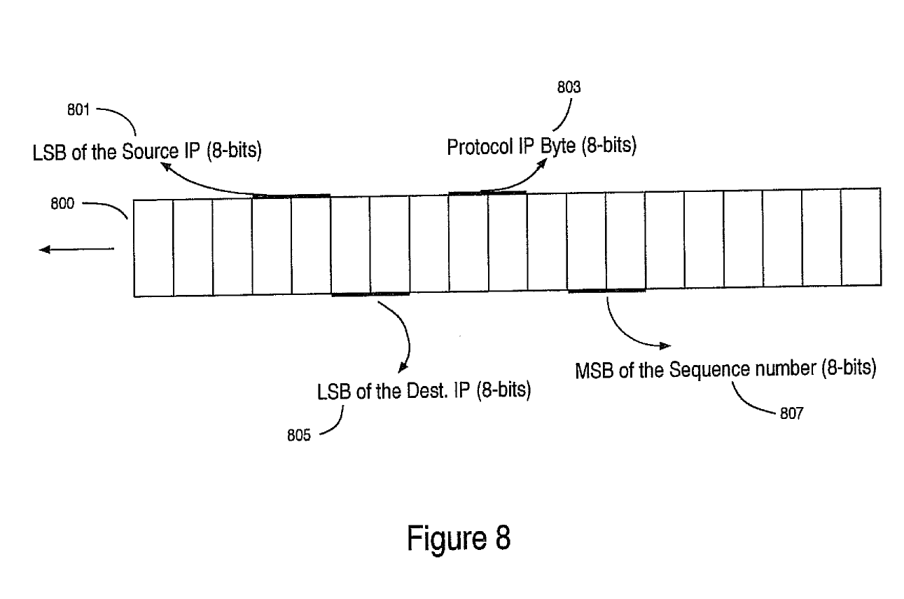

Referring now to FIG. 8, features of an incoming packet 800 in accordance with one embodiment of the present invention is shown. According one embodiment, predetermined bits of the incoming packet 800 may be used to create a unique signature for the packet. The unique signature may be used to determine various parameters related to the QoS. For example, the unique signature may be used to identify dropped packets, to measure the delay, to determine jitter, etc.

It is appreciated that in one embodiment, the predetermined bits used in creating the unique signature may include the least significant bit (LSB) of the source IP 801, protocol IP byte 803, the least significant bit (LSB) of the destination IP 805 and the most significant bit (MSB) of the sequence number 807. However, it is appreciated that the predetermined bits used may be any bits and fields of a given packet. Thus, the use of the predetermined bits described above is exemplary and not intended to limit the scope of the present invention.

An IP address assignment in IP version 4 may consist of four bytes of source and four bytes of destination address. In an active network a small portion of network addresses may be active. Thus, it is advantageous to gather information regarding the active IP addresses. In one exemplary embodiment, a unique ID may be locally assigned to active IP connections. The local IP IDs may be used within the system and can be sequentially incremented to identify active IP connections. The local IP IDs may be reused when active connections become dormant and reassigned to new connections.

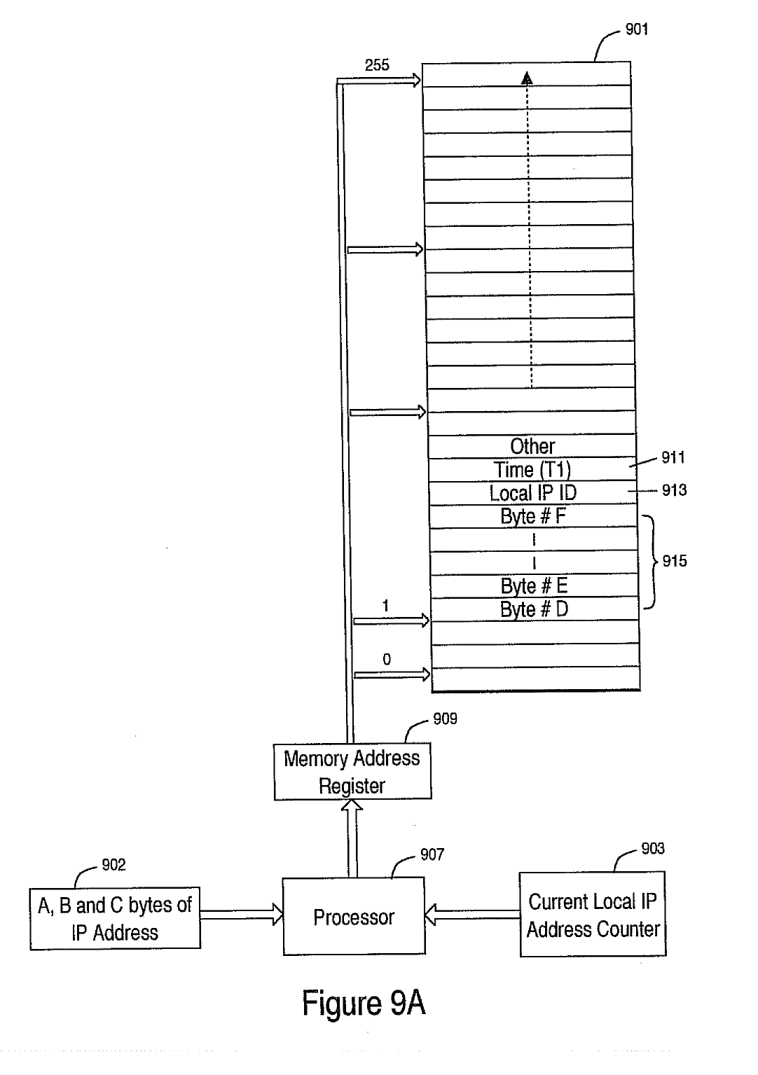

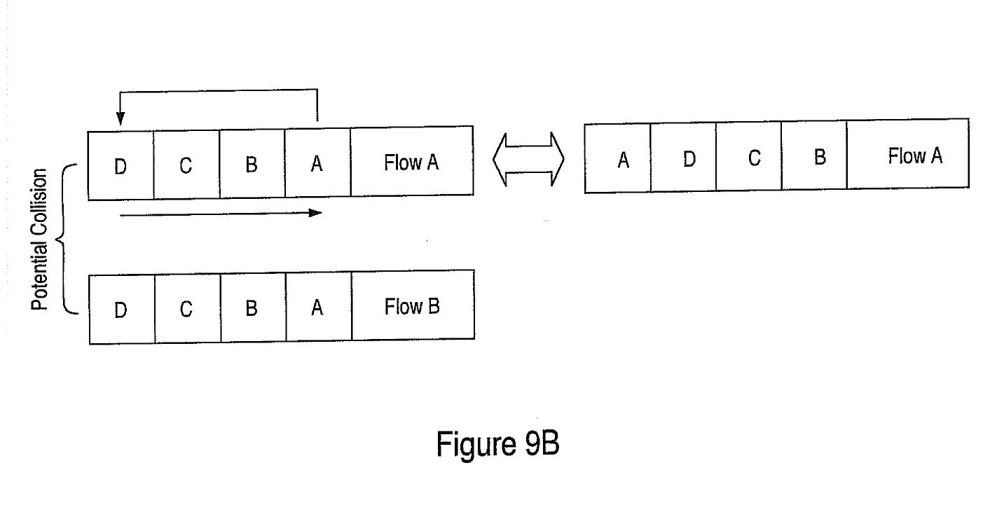

Referring now to FIG. 9A, generation of a packet flow ID in accordance with one embodiment of the present invention is shown. According to one embodiment, a processor 907 may select certain bytes from the IP address. The selected bytes may be used as address pointer to access the memory location of memory address register 909. In this exemplary embodiment, the bytes number “D” to “F” represent the bytes that were not used in selecting the address pointer. In other words, the address pointer may comprise any number of bytes of the network address. It is appreciated that the selective network bytes may be used in other IP network addresses. The stored bytes 915 may be used for comparison with the network address. For every new pair of active network connection a local IP ID may be assigned. According to one embodiment of the present invention, the internal system management and data collection may use the local IP ID. It is appreciated that the flow ID may include other parameters. Thus, the exemplary flow ID described herein is exemplary and not intended to limit the scope of the present invention.

Referring now to FIG. 9B, avoiding packet collision in accordance with one embodiment of the present invention is shown. It is advantageous to avoid collision when different packets present similar bytes in creating their respective flow ID (e.g., signature). According to one embodiment, various bytes may be reordered such that the packet flow ID of the two packets generate a different flow signature, thereby become distinguishable from one another despite using the same bytes. For example, bytes A, B, and C may be used to generate an index pointer ABC. This index pointer addresses a memory location 910. The processor may ensure that the landed location represents the designated local IP ID by comparing the stored bytes D, E and F. The index address landed represents the correct location when there is a match. The complete IP address as a combination of source and network address are different when there is a mismatch. Thus, the new pair of IP address contains the same values of A, B and C bytes. In other words, a collision occurs when there is a mismatch. In order to avoid collision the network IP bytes ABC may be reorganized. For example, the ABDC may be rotated clockwise to form CAB. The index pointer may thereafter access the memory location CAB 904. In the location CAB 904, the stored bytes of the network address may be compared to determine whether the right location is identified.

In other words, using the same bytes generates the flow signature that is the same for both flow A and flow B. Reordering the bytes of a flow, however, generates a flow signature that is different despite of using the same bytes. For example, DCBA byte for flow A may be circularly reordered to generate ADCB for flow A. Thus, using the same bytes result in a different signature flow, hence ADCB for flow A and DCBA for flow B. As such, collision between the two flows may be avoided despite of using the same bytes.

Accordingly, different addresses for different signature flows is generated even though the same bytes are used in generating the signature flows. Accordingly, data may be stored in the memory address block when the memory address block for the generated flow signature is available. It is appreciated that the circular reordering to generate distinct signature flow to avoid collision by using the same bytes is exemplary and not intended to limit the scope of the present invention. For example, the reordering may be achieved by transposing the bytes.

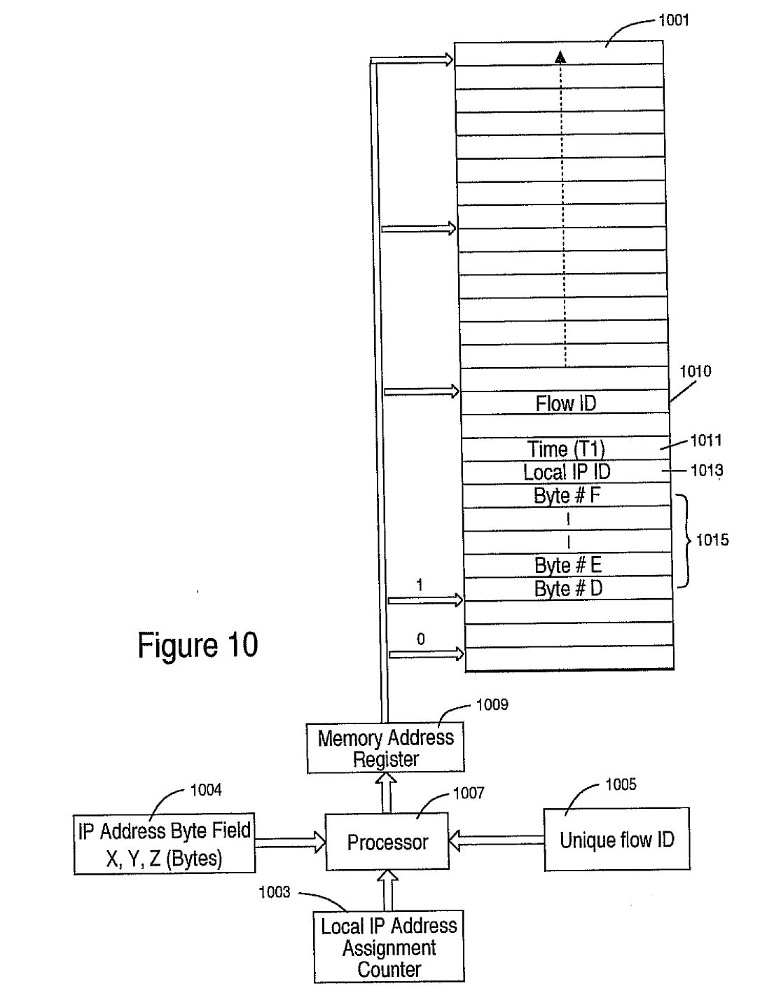

Referring now to FIG. 10, generation of flow ID based on the type of data in accordance with one embodiment of the present invention is shown. It is appreciated that any combination of IP address bytes fields 1004 representing source and destination network address fields may be used as an address pointer. For example, twenty four million location of a RAM memory may be accessed if three bytes of the network address fields are used, e.g., X, Y and Z bytes. It is, however, desirable to use a smaller number range in order to identify each of the active connections. As such, a local IP ID may be assigned for a new connection. Accordingly, a new connection may be identified by using the local IP Counter 1003 that provides a local IP ID number to the processor 1007. The local IP ID number does not only contain fewer bytes but it also represents the active connections only. It is appreciated that the memory address register 1009 and the destination IP address 1001 may function similar to that of FIG. 9A. Similarly, the destination IP address 1001 may contain various parameters, e.g., flow ID 1010, time 1011, local IP ID 1013 and bytes 1015, similar to that of FIG. 9A.

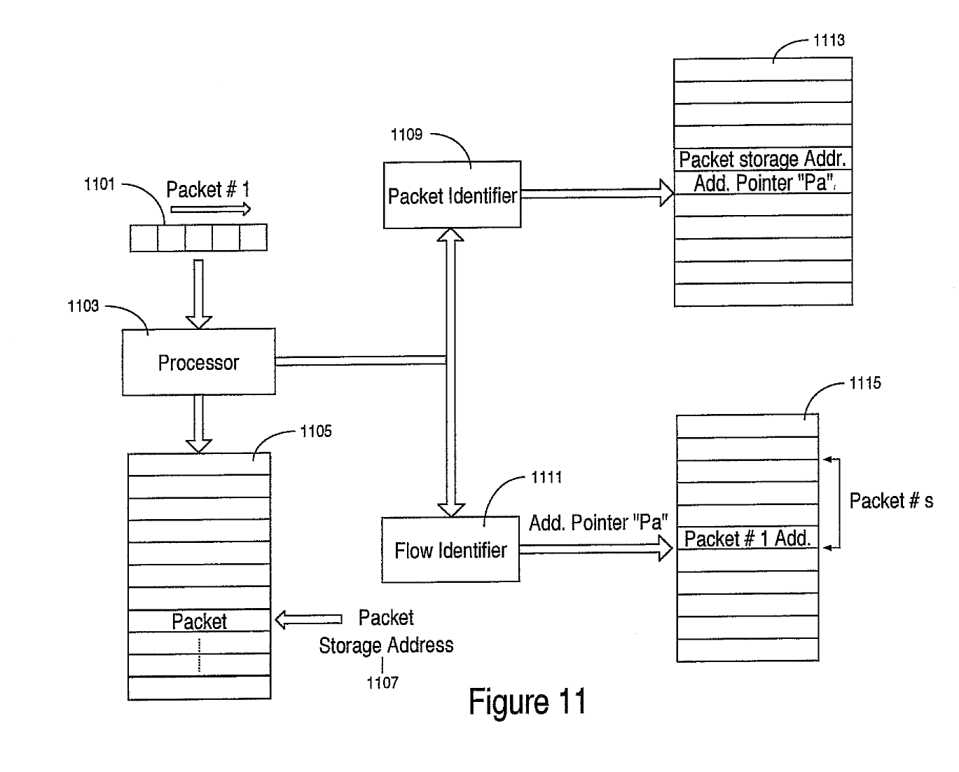

Referring now to FIG. 11, generation of a packet and flow identifiers in accordance with one embodiment of the present invention is shown. According to one embodiment, an incoming packet 1101 is accessed by a processor 1103. The processor 1103 may store a copy of incoming packet 1101 in a packet storage 1105. A packet identifier 1109 may identify the packet and a flow identifier 1111 may identify the flow that corresponds to the incoming packet 1101.

According to one embodiment, the identifier of the incoming packet may be stored in a memory 1113. Similarly, the flow identifier may be stored in a memory 1115. It is appreciated that the memory 1113 and 1115 component may be part of the same memory component or belong to memory components that are different from one another. It is appreciated that an example of a flow identifier is discussed above with reference to FIGS. 9A and 10.

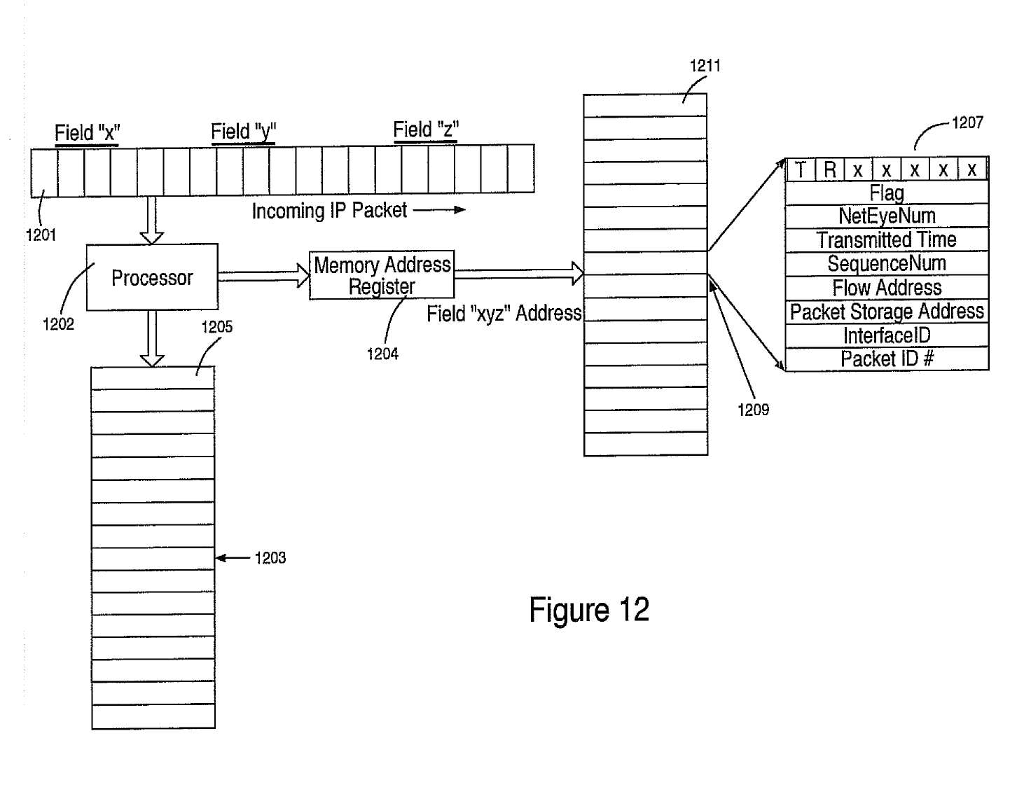

Referring now to FIG. 12, storing a packet in accordance with one embodiment of the present invention is shown. According to one embodiment of the present invention, the incoming packet 1201 may be uniquely identified. The packet flow that the incoming packet 1201 belongs to may be identified by using various fields within a given packet. The fields used to identify the packet flow may be located in the header of the packet and/or in the payload of the packet. For example, the fields “Field “x”, Field “y” and Field “z” can represent certain bit locations within the packet. These bits may be unique for each packet that belongs to a given packet flow. For example, two bytes of an IP ID field may be unique to packets that belong to a given IP packet flow.

In one embodiment, a hash signature of a packet may be calculated by a processor 1202 in order to identify the flow that corresponds to the packet. The hash signature can uniquely represent the packet. A memory address register 1204 may receive the hash signature in order to access the memory location 1211. The memory location 1211 may be divided into sub-blocks 1209 where each sub-block may contain information regarding the packet flow, e.g., NetEye number is the system ID number that tracks the communication device used in a given packet flow. Other information may include transmitted time, sequence number, flow address, packet storage address, interface ID, packet ID number, etc.

Transmitted time provides information as to when the packet is transmitted. The packet sequence number may identify a specific sequence number of the packet in a given packet flow. The flow address may identify the flow ID of the packet. The packet ID number field may uniquely identify the packet. The packet storage address identifies a shared memory location where the actual packet is stored. The interface ID number may identify the interface where the actual packet is transmitted.

In one embodiment, data related to the data packet being transmitted and the measured performance information regarding various network paths are identified. Data may include the transmitted time of the data packet. Other information may include a delay that may be defined as the time it takes for a packet to travel from a source node to a destination node. As a result, the delay may be determined by subtracting the transmitted time from the arrival time. In one embodiment, the transmitted time and the arrival time can be obtained from data stored by the standalone component 631D in FIG. 6D.

As described above, the standalone component 631D manages packet flow by forwarding a packet based on various criteria, e.g., based on the measured performance obtained from the confirmation packet. Various network paths performance may be measured by generating a confirmation packet and transmitting the confirmation packet to a standalone component, e.g., standalone component 631D.

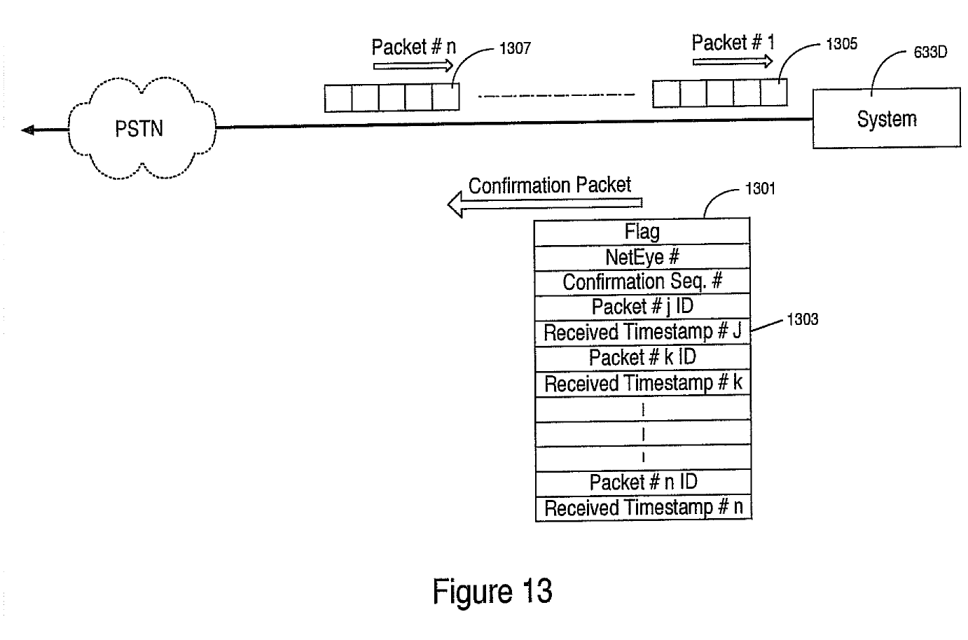

Referring now to FIG. 13, a confirmation packet in accordance with one embodiment of the present invention is shown. It is appreciated that a confirmation packet, e.g., 1301, may record the arrival time of a packet at a predetermined point, e.g., standalone component 633D. The confirmation packet 1301 may include the received timestamp 1303 for identifying the arrival time of the forwarded packet, e.g., 1301, 1305, 1307, etc., at the standalone component 633D.

According to one embodiment of the present invention, the confirmation packet 1301 may also include a unique packet ID number. Packet ID number may be used to identify the memory sub-block where the information regarding the incoming packet is stored. According to one embodiment, the delay may be determined by subtracting the transmitted time as stored in data storage space of FIG. 12 from the arrival time as provided by the timestamp 1303 in the confirmation packet shown in FIG. 13.

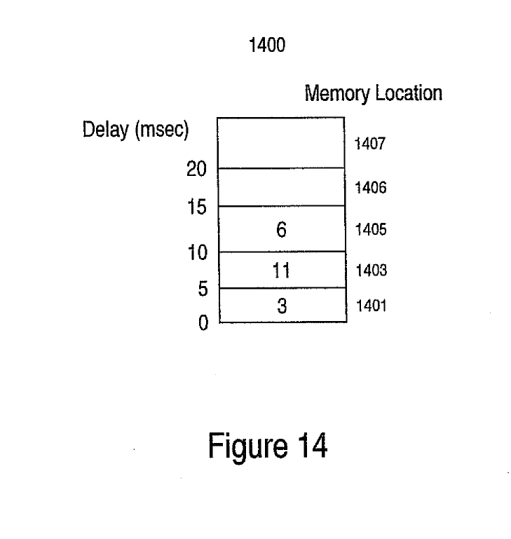

Referring now to FIG. 14, identifying packets within a packet flow that are within a predetermined delay range in accordance with one embodiment of the present invention is shown. A storage space 1400 may be divided into sections where each section represents a delay range. The number of packets within each of the sections may be determined and updated by counting the packets that are within each of the predetermined delay ranges. For example, the data storage space 1400 may be divided into sections 1401-1407. 1401 section may correspond to delays between 0 to 5 milliseconds. Thus, the total number of the packets within 0 to 5 milliseconds delay range is stored in section 1401, e.g., 3 packets.

Similarly, section 1403 may correspond to packet delays that are within 5 to 10 milliseconds. As such, the total number of packets, e.g., 11, that have a delay time between 5 to 10 milliseconds may be stored in section 1403. Similarly, a third section 1405 may be used to correspond to the number of packets, e.g., 6, that have a delay between 10 to 15 milliseconds. The information within the memory 1400 may be provided to a data collection and analysis system to generate a performance analysis, e.g., graphs of the performance of the corresponding network path delays.

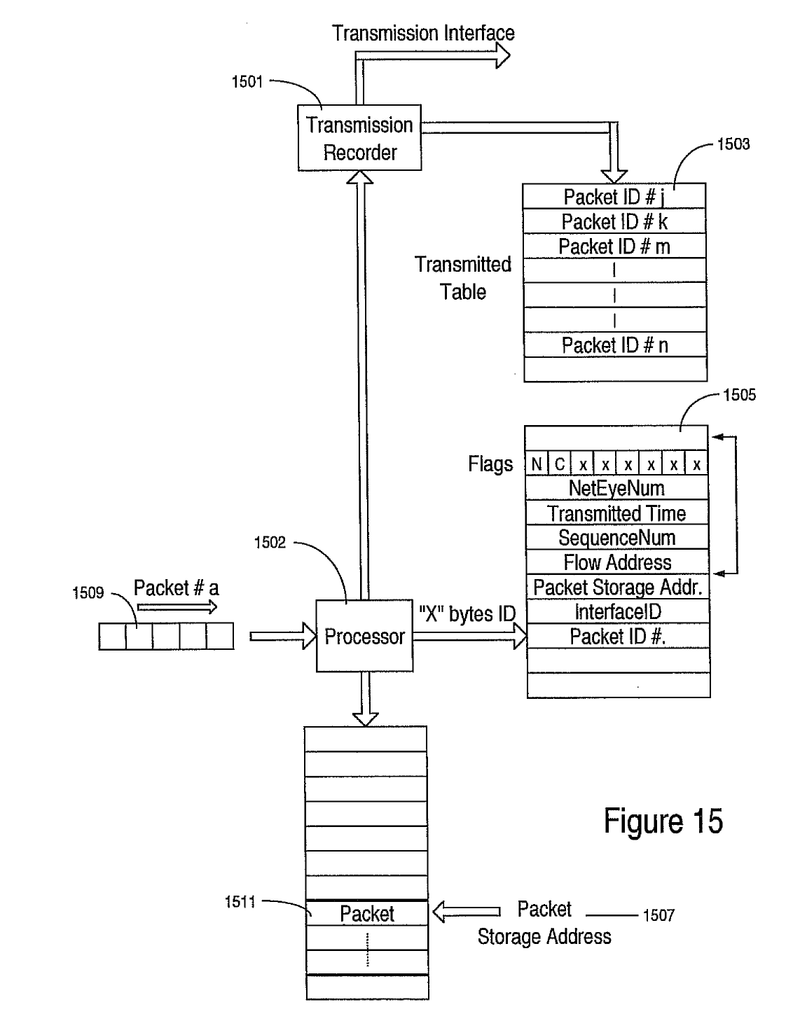

Referring now to FIG. 15, tracking transmitted packets in accordance with one embodiment of the present invention is shown. According to one embodiment, dropped packets may be identified by referencing the packets transmitted and the confirmation packets of the packets transmitted. A processor 1502 may store information related to the transmitted packets in a sub-memory block 1505. A transmission recorder 1501 may keep track of the transmitted packets in the same sequence as they were transmitted by storing them in a transmitted table 1503.

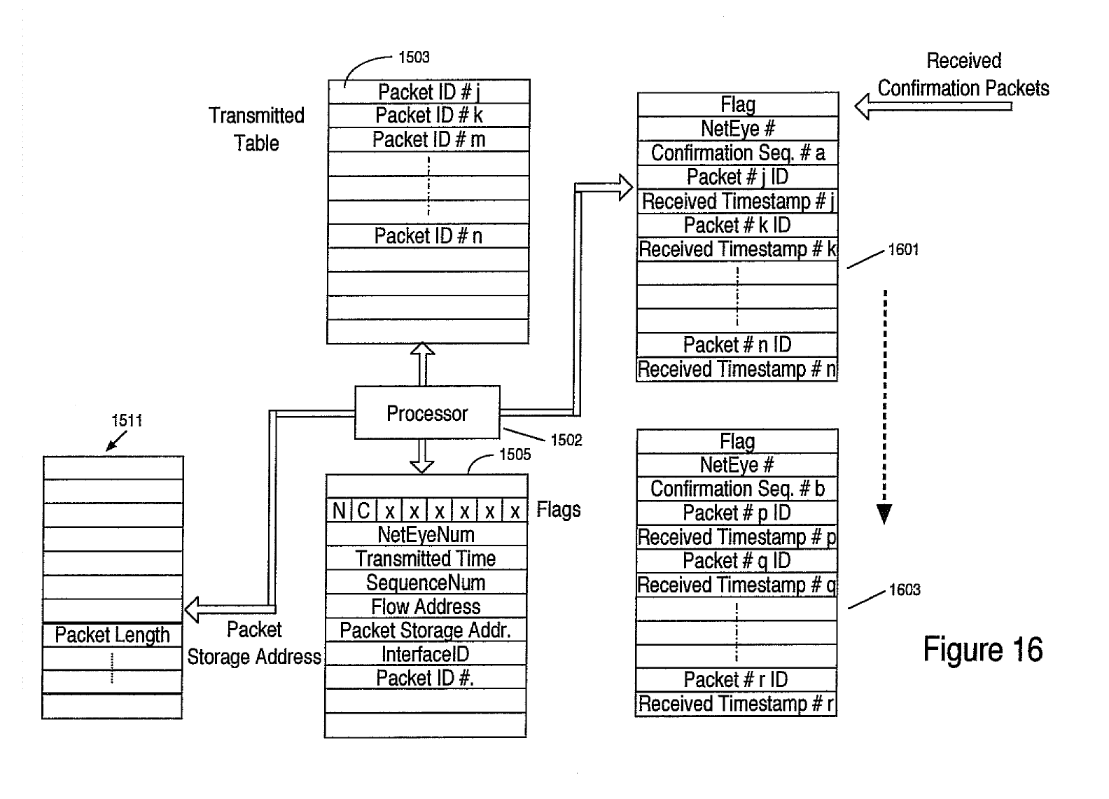

Referring now to FIG. 16, comparing a sequence of confirmation packets with the transmitted packet table to identify the dropped packets in accordance with one embodiment of the present invention is shown. A sequence of confirmation packets, e.g., 1601 and 1603, that are received, may be compared to the transmitted packet table 1503 in order to identify missing packets, e.g., dropped packets.

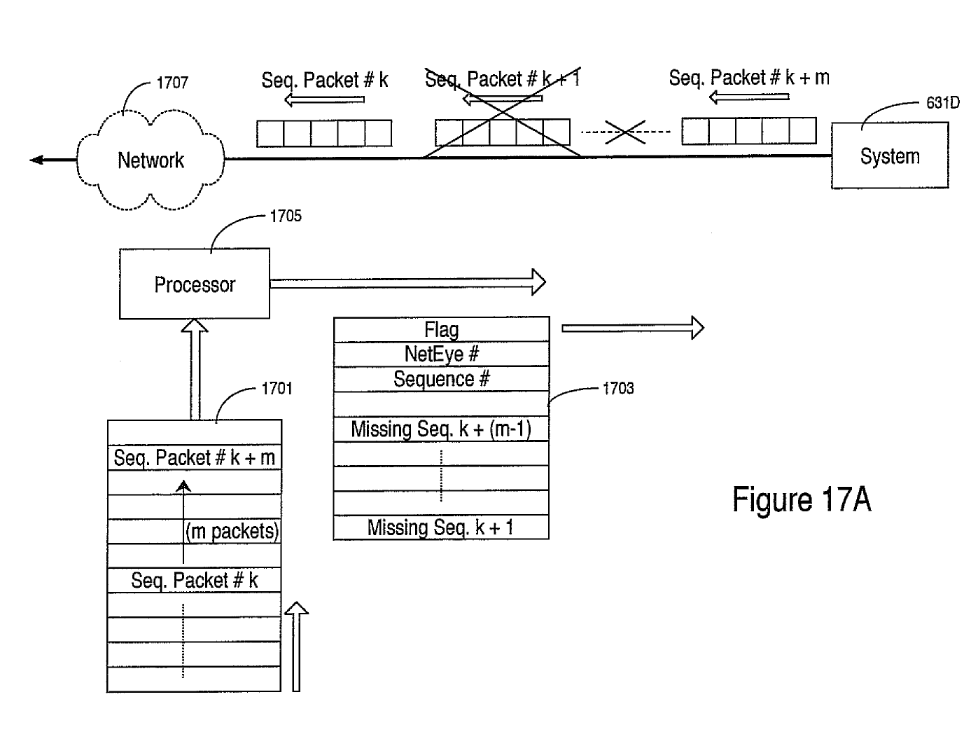

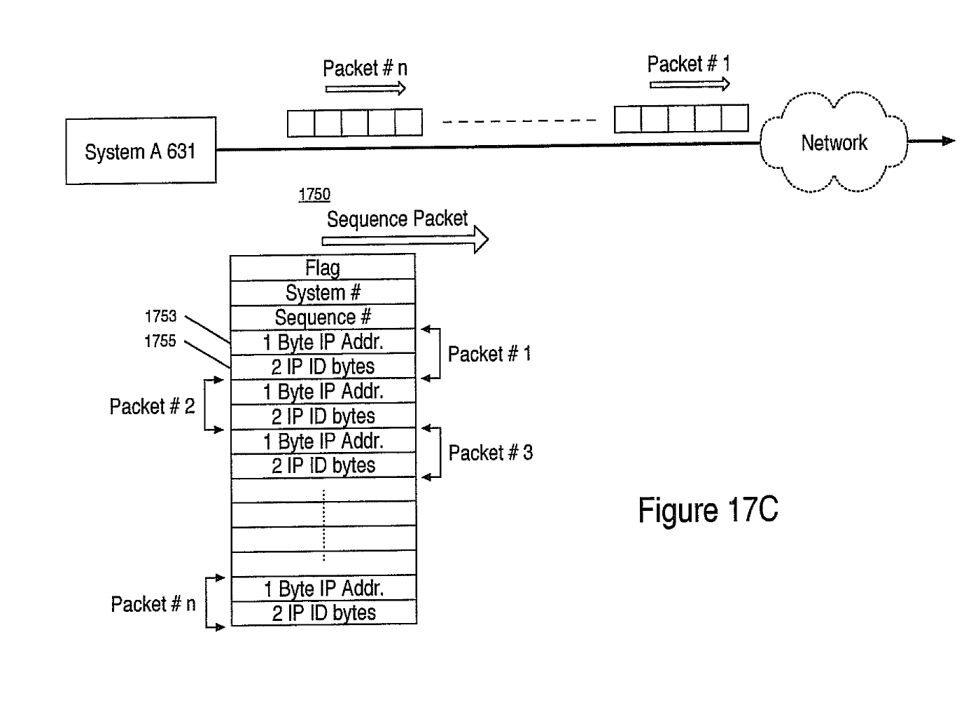

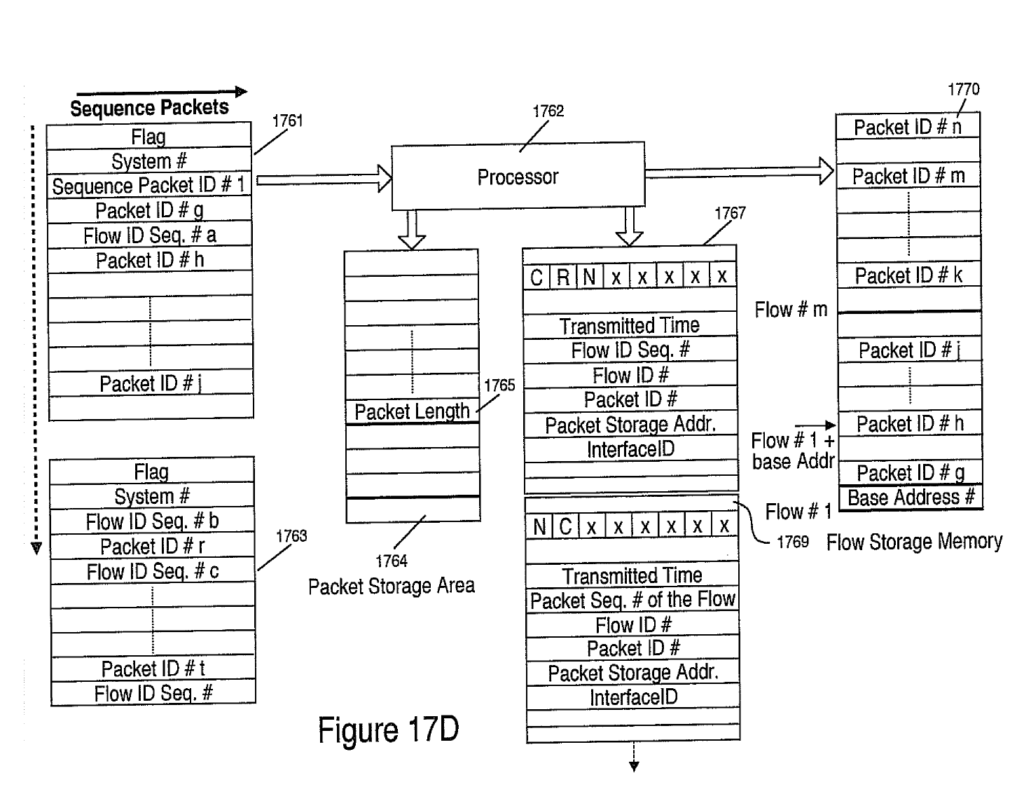

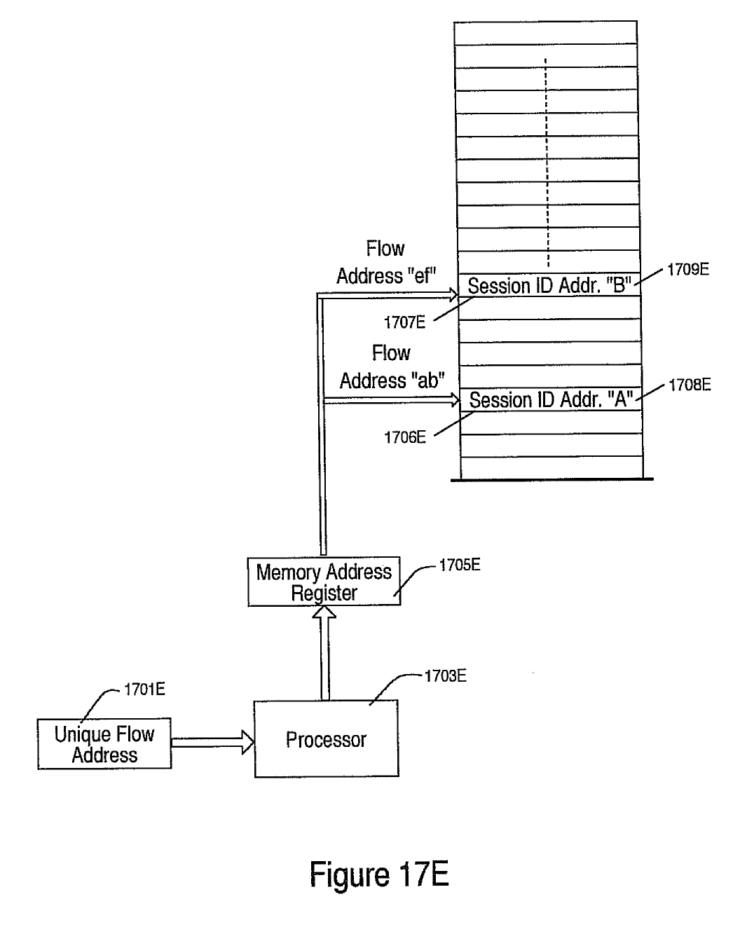

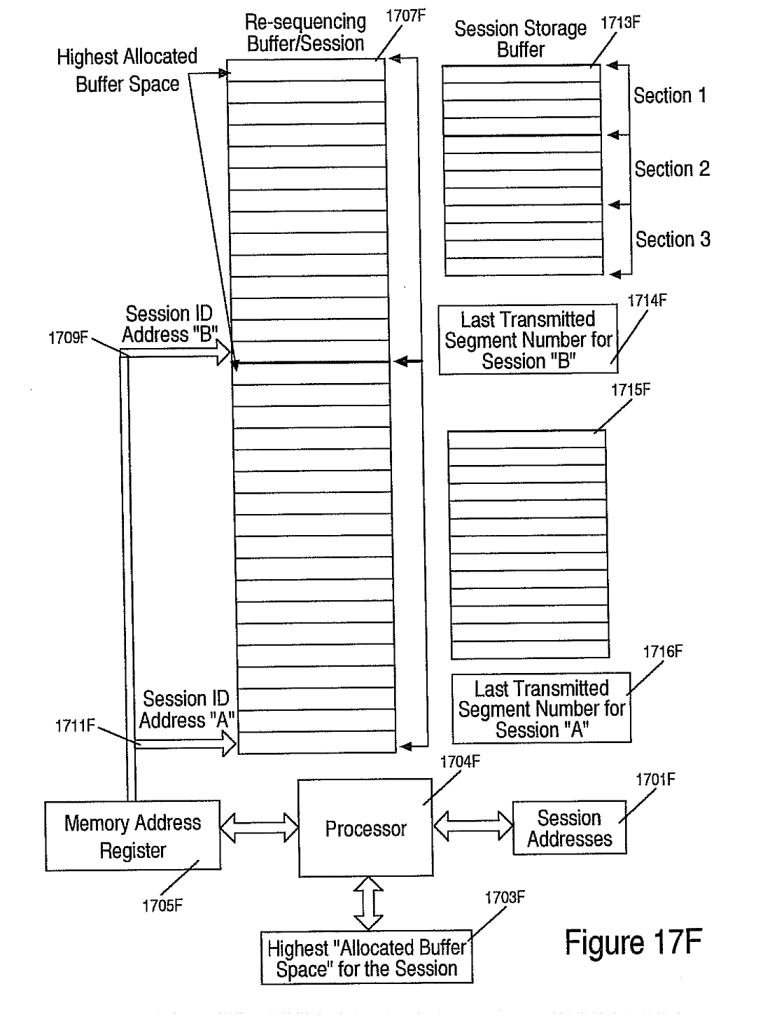

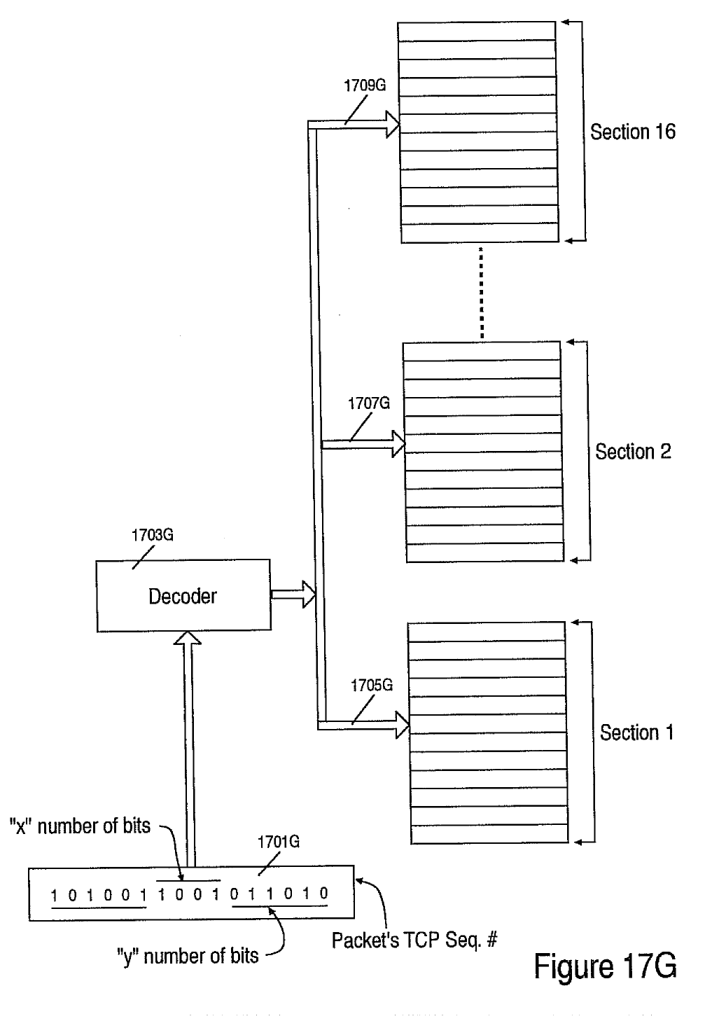

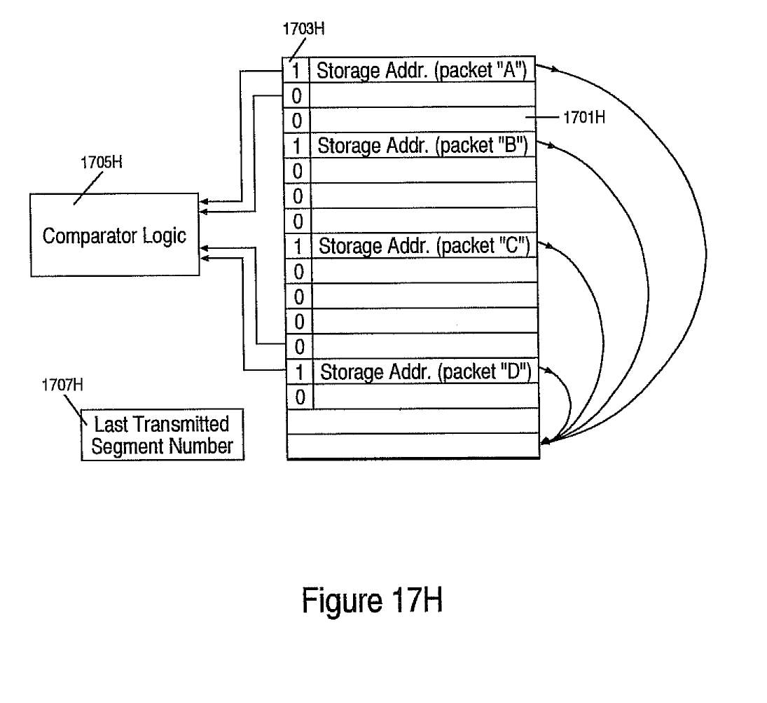

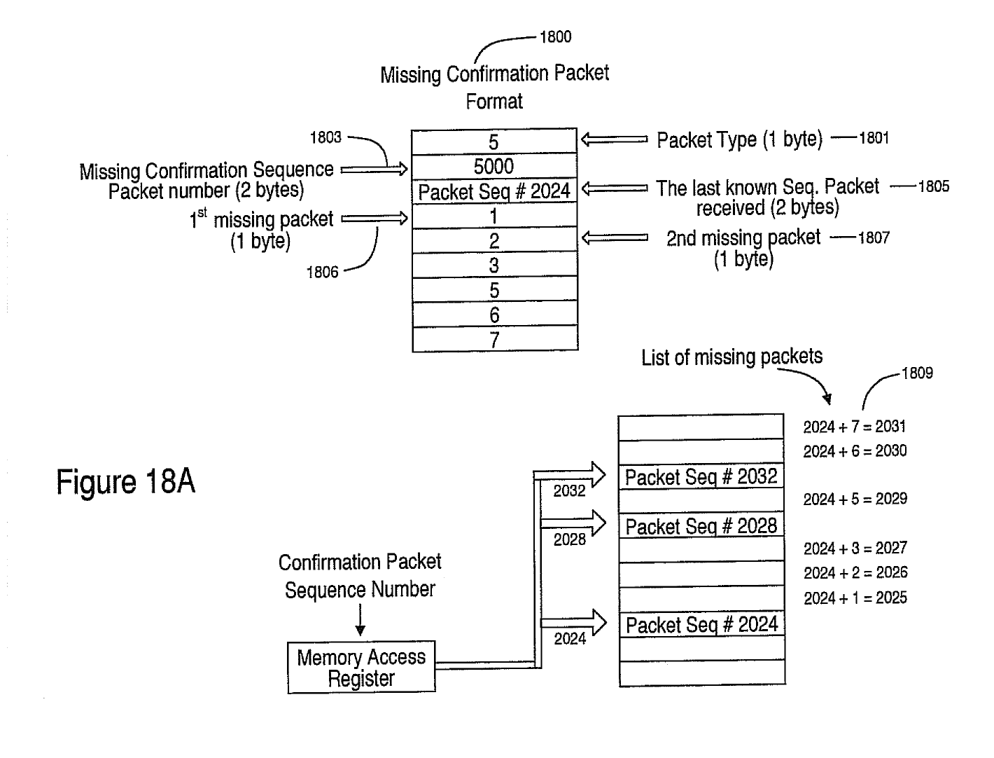

Referring now to FIG. 17A, identifying sequence packets in accordance with one embodiment of the present invention is shown. A plurality of sequence packets, e.g., sequence packets k, k+1, k+(m−1) and k+m, is transmitted from the standalone component 631D to a network 1707. Sequence packets k+1 and k+(m−1) are shown to be missing, e.g., dropped, as represented by a cross through the sequence packet. The series of sequence packets, e.g., sequence packets k, k+1, k+(m−1), k+m, etc., may be recorded by a transmission recorder 1701. According to one embodiment, the recorded sequence of the transmitted packets may be compared to information provided by confirmation packet 1703 in order to identify the missing sequence packet, e.g., sequence packets k+1 and k+m−1. It is appreciated that the missing sequence packets may be stored in a memory component 1703.

Referring now to FIG. 17B, retransmission of a dropped packet in accordance with one embodiment of the present invention is shown. A confirmation packet 1713 may contain information that can be used to identify the dropped sequence packet 1711. For example, the confirmation packet 1713 indicates that packet numbers a and k have been received and time stamped accordingly. Comparing the transmission record table to that of the confirmation packet identifies the dropped packets, e.g., packet b 1715. Thus, the standalone component 631D may request retransmission of the dropped packet only, e.g., packet b, m and n. For example, the received confirmation packet 1713 may be used to identify that the sequence packet number 1711 has been dropped and therefore not received. The standalone component 631D may send the dropped packets from a stored copy of the packets instead of having to access a server to obtain the dropped packet. It is appreciated that the standalone component 631D may also transmit the sequence packet number 1711 from the stored copy of the packets.

Referring now to FIG. 17C, an exemplary format of a sequence packet in accordance with one embodiment of the present invention is shown. According to one embodiment, a system 631D may transmit a sequence packet after transmitting “n” number of packets. The information contained in the sequence packet may be used to restore the original sequence of the packets as transmitted through different network paths having differential delays and throughput links. A typical sequence packet may consist of a system number 1751 comprising information about the source. The sequence packet field 1752 may indicate the sequence number of the sequence packet. The packet ID number may represent the unique identification of the packet and/or the number that uniquely identifies the packet. The flow ID sequence number field comprise the unique number that may identify the flow ID that the packet belongs to. It is appreciated that the described formats are exemplary and not intended to limit the scope of the present invention.

Referring now to FIG. 17D, re-sequencing out of order packets in accordance with one embodiment of the present invention is shown. Information within transmitted sequence packets, e.g., sequence packets 1761 and 1763, may be used to sequence the packets that belong to a given packet flow.

It is appreciated that packets have different delays when the packets are transmitted from a sending device via different network paths to the receiving device. Different delays of different network paths may cause the receiving device to receive the transmitted packets out of sequence. It is appreciated that the received packets are stored in the packet storage area 1764 when received. As discussed above, each data packet may be identified by a unique packet ID. The processor 1762 may use the received packet ID to identify the unique sub-block. Each unique sub-block 1765 may be used to store certain characteristics of the packets. For example, the unique sub-block 1765 may be used to store the transmission time, flow ID sequence number, flow ID number, packet ID number, packet storage address, interface ID, etc., for a given packet. It is appreciated that any kind of information may be stored and the stored data described above are exemplary and not intended to limit the scope of the present invention.

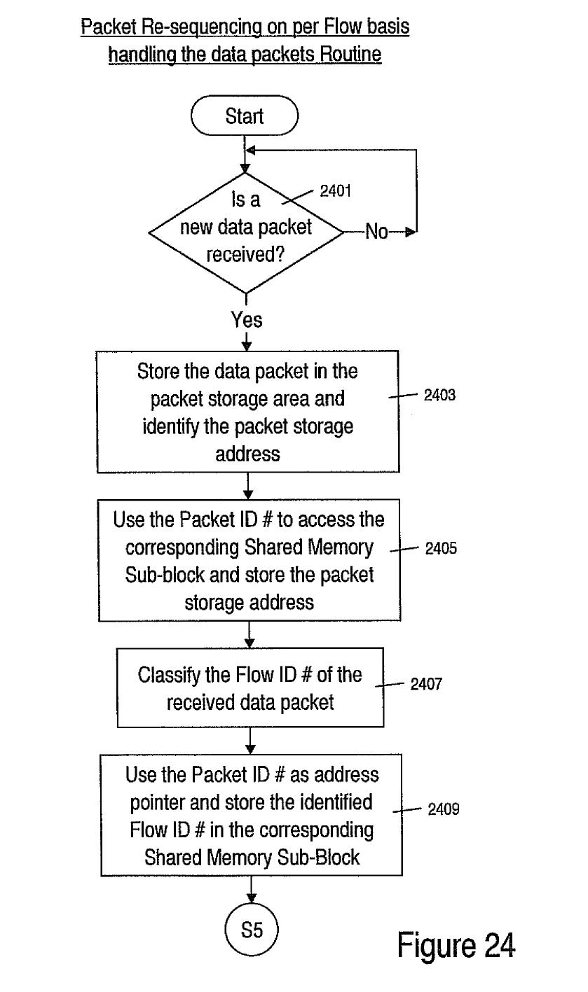

According to one embodiment of the present invention, the stored packet is not transmitted until it is confirmed that the information embedded within the relevant sequence packet are in the proper order. In one embodiment, the identification of the right transmission sequence of the packets is achieved by using the flow ID sequence filed values and the Packet ID numbers. The processor 1762 may keep track of the packet ID numbers by storing them in the shared memory sub-blocks and by storing the packet sequence number of the flows in the flow storage memory 1170. FIGS. 23-28 provides various embodiments to maintain the right sequence of the received packets.

It is appreciated that the packet ID number for each packet that belongs to a given packet flow may be associated together in flow storage memory 1770. Therefore, the packet ID number may be used to reorder the received packets. For example, the packet ID number may be used to reorder the received packets in a chronological order. Accordingly, received packets for a given packet flow can be reordered in order to reassemble the original transmitted packet in their original sequencing format.

Referring now to FIG. 17E, assembling out of sequence packets in accordance with one embodiment of the present invention is shown. According to one embodiment, a packet sequence number may be used in order to reassemble the received packets. For example, a unique flow address 1701E may be provided as an input to a processor 1703E. The processor 1703E causes a memory address register 1705E to identify and access the corresponding memory address, e.g., memory address 1706E, memory address 1707E. Accessed memory addresses may contain a session ID address identifier, e.g., session ID addresses 1708E and 1709E. In one embodiment, the session ID address identifier may be used to identify a memory storage location of a re-sequencing buffer, as shown in FIG. 17F below, to re-order the received packets.

Session ID may be used for the packet types that contains sequence numbers within the packets. For example, TCP, RTP, etc., types packets may have fields that contain the sequence numbers. In a conventional TCP re-sequencing algorithm, the packets are discarded and retransmitted even if a few out of sequence packets are received. Thus, the conventional method imposes a strict limitation on the transmitting host not to send out of sequence packets. Embodiments of the present invention provide a scheme by which out of sequence packets may be properly sent and reassembled when received.

Referring now to FIG. 17F, reordering out of sequence packets in accordance with an embodiment of the present invention is shown. According to one embodiment, the incoming session number may be first compared to the active session number and active section 1703F. The value of the “y bits” may be used to identify the position of the session in the re-sequencing buffer/session when the incoming session number falls within the range of an active section. In one embodiment, there may be four sessions, e.g., 1706F, 1707F, 1708 and 1709F. The processing of these sessions is discussed in FIG. 17H described below. The active section may be formed in a round robin fashion. As illustrated, there are “N” numbers of sections. When the sessions stored in a section are sequenced then the pointer may navigate to the next section in order to arrange the sessions in the right sequence. Sessions stored in section 1 may be processed first. The next sections may be processed in round-robin fashion

In one embodiment, the storage addresses in the overflow buffer 1713F may be transferred to their corresponding portion of the re-sequencing buffer 1707F when data in the portion of the re-sequencing buffer 1707F is cleared to free up space. It is appreciated that the corresponding portion of the re-sequencing buffer 1707F that the overflow storage addresses are being transferred to are associated to the same session. In one exemplary embodiment, the storage addresses in the overflow buffer 1713F that are being transferred to the portion of the re-sequencing buffer 1707F, corresponding to the same session, may be based on the sequence number of the related packets.

Referring now to FIG. 17G, decoding of the sequence number to identify a corresponding address in a re-sequencing buffer in accordance with one embodiment of the present invention is shown. The decoder 1703G may identify the section address of a packet TCP sequence number 1704G. The identifiable bits represented as “x number of bits” may be used to identify the sections. It is appreciated that any permutation in these bits may be used to represent any one number of sections. The sessions identified through the number of “y” bits may be stored randomly in any one of the sections.

In other words, according to this embodiment, a packet data may be used to determine which buffer and which address of the buffer to be used to store the address of the packet. The decoder 1703G may receive a packet sequence number 1701G corresponding to the received packet. The decoder 1703G may identify a corresponding memory address space sections, e.g., section 1, section 2, section 16, etc., and their corresponding locations, e.g., 1705G, 1707G and 1709G. The locations 1705G, 1707G and 1709G may identify the location to store the packet.

In one embodiment, the referenced “x number of bits” 1001 may determine the specific buffer where the packet address is to be stored. The sequence number may determine the place in the buffer where the packet address is to be stored.

Referring to FIG. 17H, disabling addresses that do not contain data in accordance with one embodiment of the present invention is shown. Packet addresses A through D are stored in memory addresses correspond to its packet sequence number. Unoccupied memory address locations, e.g., 1701H, may exist between the memory address locations that are occupied by stored packet storage addresses. In one embodiment, a bit 1703H may be associated with each memory location for indicating whether the memory location is occupied. For example, a logic value “1” can correspond to occupied and logic value “0” can correspond to unoccupied.

In one embodiment, to re-order the received packets, the occupied memory address locations are directly accessed without examining unoccupied memory locations. Occupied memory addresses may be directly accessed without examining unoccupied memory locations because the unoccupied locations are disabled by the comparator logic 1705H (unoccupied locations driven to tri-state level).

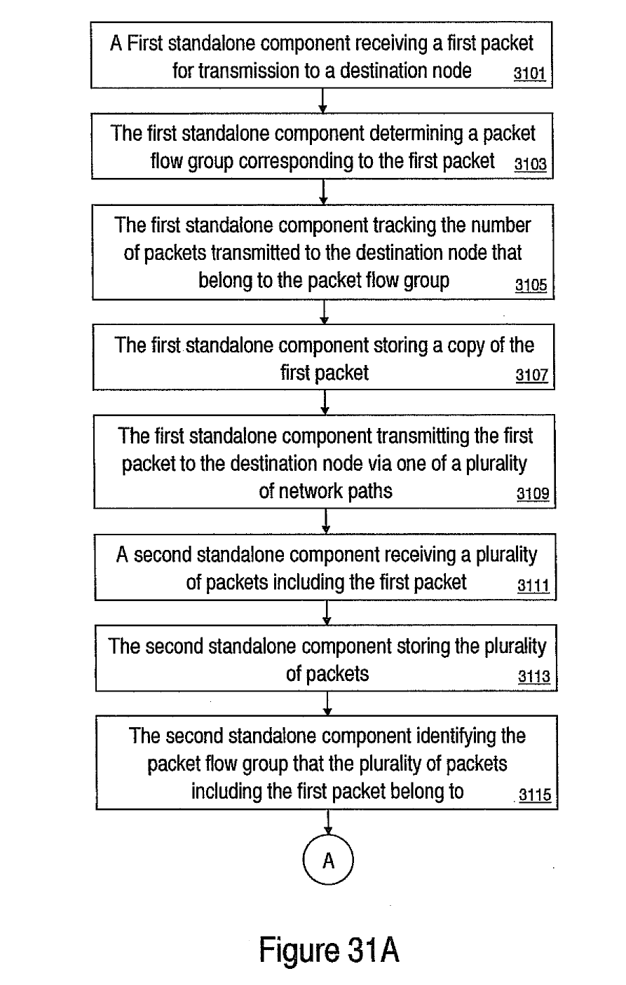

In one embodiment, the length of the packets associated with the stored packet storage addresses (A-D) may be added to the sequence number of the last transmitted segment 1707H. The result may be compared with the sequence number of the packets associated with the stored packet storage address. A match identifies the packet as the next packet to be transmitted. Subsequently, the packet corresponding to the packet storage address is transmitted and the packet storage address is erased from the re-sequencing buffer. This process is further described in FIG. 30 below.

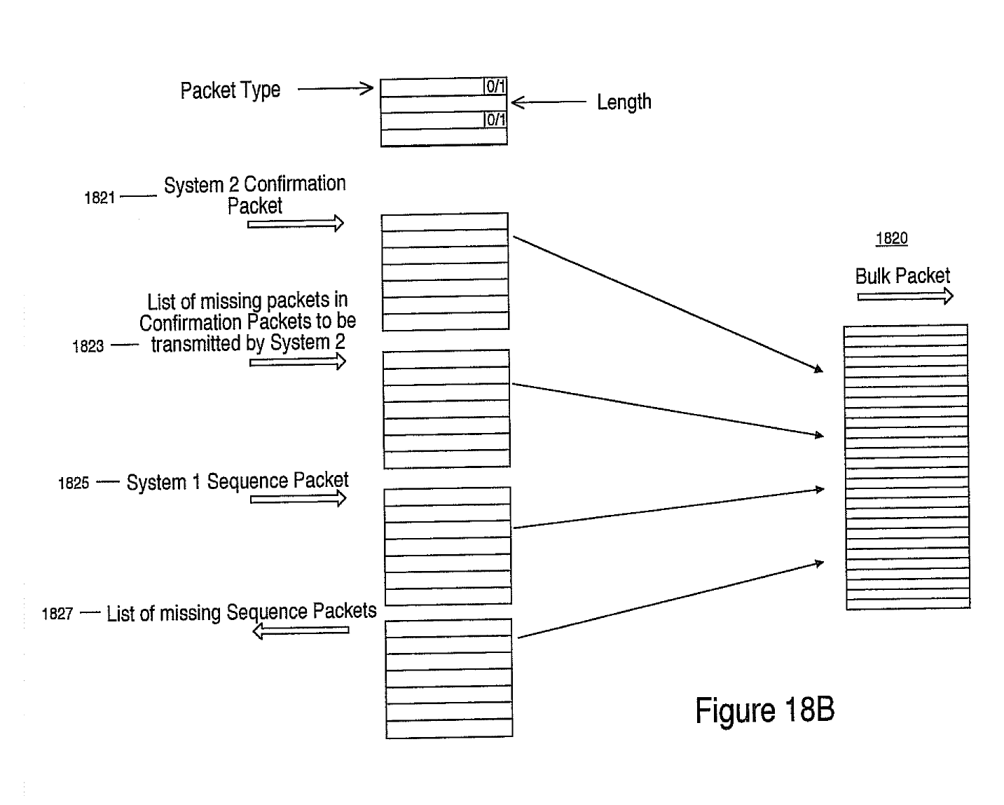

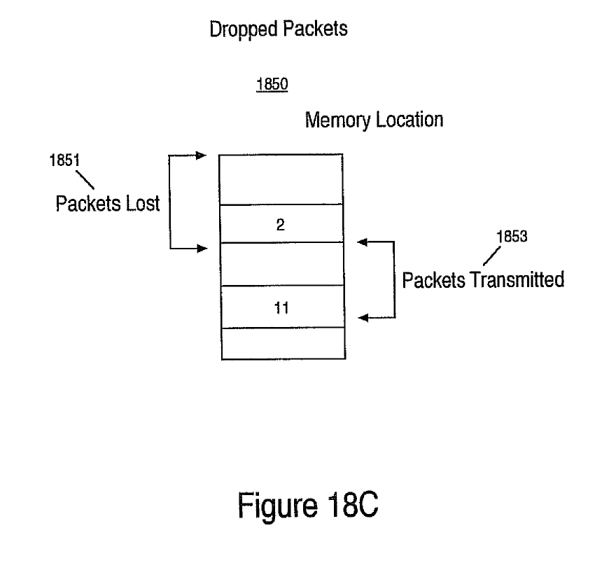

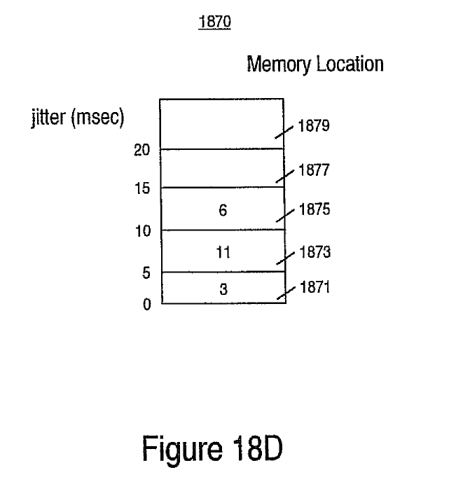

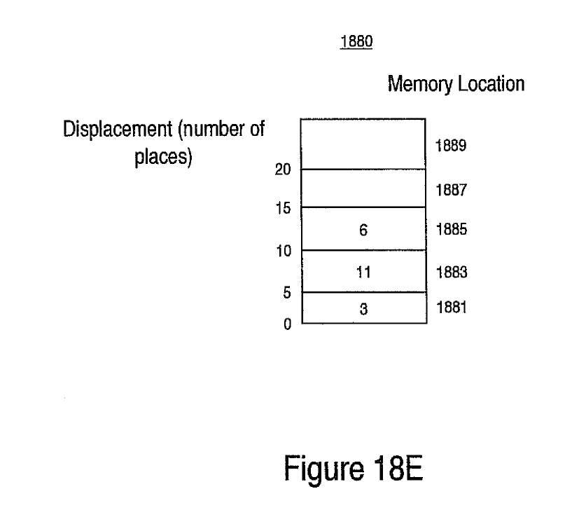

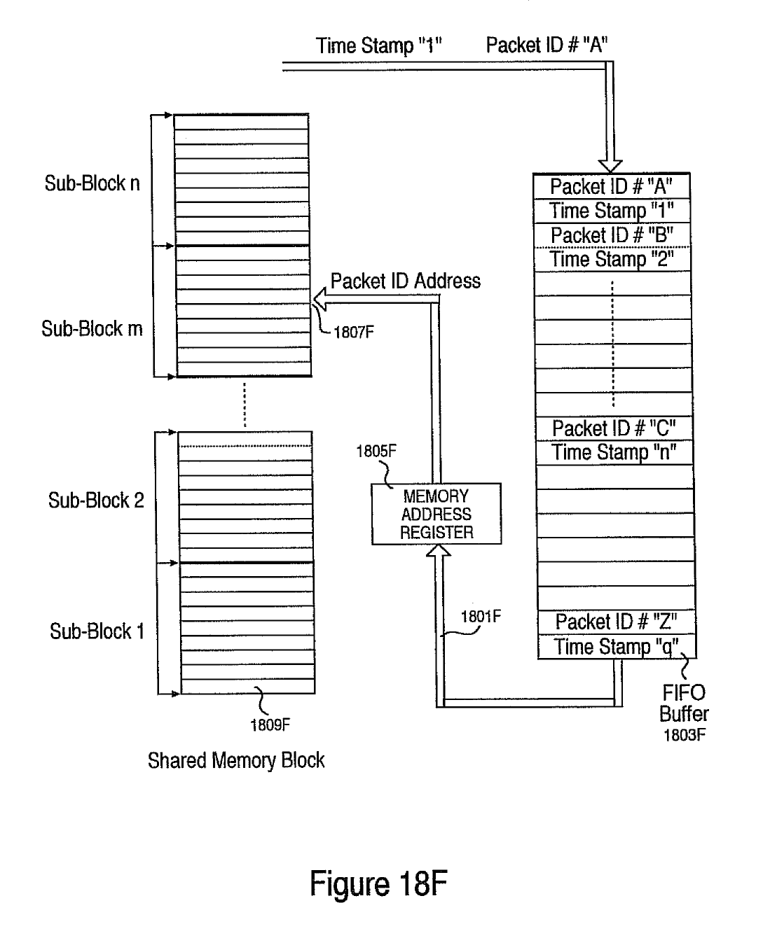

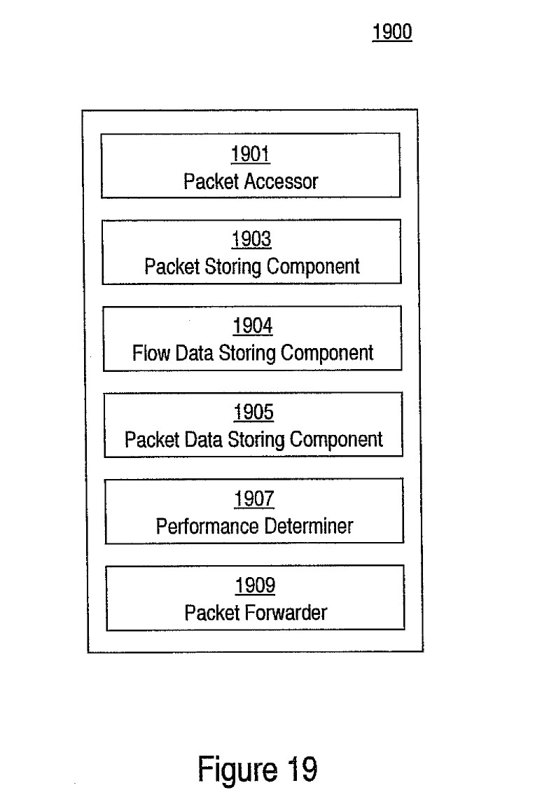

Referring now to FIG. 18A, a confirmation packet for identifying missing packets in accordance with one embodiment of the present invention is shown. A confirmation packet format 1800 for identifying missing packets may include a packet type 1801, missing confirmation sequence packet number 1803 and the last known sequence packet received 1805. The confirmation packet 1800 may further include the first missing packet 1806 and the second missing packet 1807. According to one embodiment, packets that are transmitted after the last known received sequence packet are tracked. For example, the last received sequence of packet is sequence number 2024. As such, packets following the 2024 sequence number are tracked.

The order of the missing packets among the received packets is registered. For example, packets 1, 2, 3, 5, 6 and 7 that follow the 2024 sequence number are missing. As such, the missing packets may be identified. Therefore, adding the numbers that correspond to the orders of the missing packets, e.g., 1, 2, 3, 5, 6, and 7, to the last known sequence packet received, e.g., 2024, identifies the packet sequence number of each of the missing packets 1809.

Referring now to FIG. 18B, compilation of a bulk packet in accordance with one embodiment of the present invention is shown. According to one embodiment, a bulk missing packet 1820 is generated when the number of missing packets is greater than a predetermined value. The bulk missing packet includes the sequence numbers for the missing packets.

In one embodiment, the bulk packet 1820 may be generated even though the number of missing packets is not greater than a predetermined value. For example, the bulk packet 1820 may be generated when a predetermined amount of time has elapsed. The bulk packet 1820 may include the sequence numbers for the missing packets.

It is appreciated that the bulk packet 1820 may be transmitted to the standalone components 631D and 633D for management of packet flow in a network. In one exemplary embodiment, the bulk missing packet 1820 includes a confirmation packet 1821 from the standalone component 633D and the list of missing packets in confirmation packets 1823 to be transmitted from the standalone component 633D to the standalone component 631D. The bulk missing packet 1820 may further include a sequence packet 1825 from the standalone component 631D and list of missing sequence packets 1827.

Referring now to FIG. 18C, identifying the number of dropped packets in accordance with one embodiment of the present invention is shown. A data storage space 1850 may be divided into sections that correspond to lost packets (e.g., dropped packets) 1851 and transmitted packets 1853. In one embodiment, the transmitted packets 1853 may be compared to a list of received packets as identified by the confirmation packet. Accordingly, missing packets, e.g., dropped packets, may be identified as discussed above. The result of the comparison may be stored in the lost packet portion 1851 in order to count the number of dropped packets.

It is appreciated that for every additional packet drop, the number of dropped packet in 1851 may be incremented. For example, when another dropped packet is detected, the number 2 representing the number of dropped packets is incremented to 3. As such, the collected information may be used to calculate various performance attributes of the network path. For example, graphs representing the delay attribute of the performance may be plotted. Similarly, the number of dropped packets as a function of time and/or delay may be plotted in order to determine the performance of network.

Referring now to FIG. 18D, identifying the number of packets within a predetermined jitter in accordance with one embodiment of the present invention is shown. Jitter may be defined as the intermediate delay between accesses of two adjacent packets. Accordingly, jitter can be determined by ascertaining the arrival time of adjacent packets transmitted to a receiving component from a transmitting component and determining the difference between the two times.

A data storage space 1870 may be used to identify the number of packets in a packet flow that fall within a predetermined jitter range. In one embodiment, the storage space 1870 may be divided into multiple sections, e.g., 1871, 1873, 1875, 1877 and 1879. Each section may represent a jitter range and stores the number of packets that fall within that range. For example, section 1871 represents packets that have a jitter between 0 to 5 milliseconds. Thus, the number of packets, e.g., 3 packets, that have a jitter within 0 to 5 milliseconds, is stored in section 1871.

Similarly, section 1873 may represent packets that have a jitter within the range of 5 to 10 milliseconds. Thus, the number of packets, e.g., 11 packets, fall within the 5 to 10 milliseconds range and the number is stored in section 1873 memory. Similarly, a third jitter range 1875 corresponds to jitter of 10 to 15 milliseconds and may store the number of packets, e.g., 6 packets, that fall within the range. It is appreciated that the number of sections and the range are exemplary and not intended to limit the scope of the present invention. For example, the range may be 3 to 5 milliseconds. The stored information may be used in statistical analysis to measure and calculate various attributes related to the performance of network paths.

Referring to FIG. 18E, identifying the number of packets within a predetermined displacement range of the original transmission order in accordance with one embodiment of the present invention is shown. A data storage 1880 may be used to store the number of packets within a given packet flow that fall within a predetermined range of displacement from their original transmission order.

According to one embodiment, the data storage 1880 may be divided into sections where each section represents displacement range and each section stores the number of the packets that fall within each range. It is appreciated that the number of packets stored are for a given packet flow. The data storage 1880 may be divided into sections 1881, 1883, 1885, 1887 and 1889 corresponding to range 0-5, 5-10, 10-15, 15-20 and 20-25 respectively. For example, 3 packets are displaced between 0 to 5 packets and are stored in section 1881. Similarly, 11 packets are displaced between 5 to 10 packets and are stored in section 1883. Moreover, 6 packets are displaced between 10 to 15 packets and are stored in section 1885.

It is appreciated that the number of sections and the range may vary and that the exemplary numbers provided are for illustration purposes and not intended to limit the scope of the present invention. The information stored in the data storage 1880 may be used to analyze various attributes related to the network paths, e.g., displacement of received packets, etc. For example, a graphical representation of various performance attributes may be generated and displayed.

Referring to FIG. 18F, clearing a shared memory buffer in accordance with one embodiment of the present invention is shown. As discussed above, each sub-block, e.g., sub-block 1, sub-block 2 and sub-block n, in the main shared memory block 1809F may be used to store the transmission characteristics of each Flow. It is advantageous to clear up the memory sub-blocks when the information for each flow has been processed. Individual packets that access the shared memory block may be stored in a sequential manner in the FIFO buffer 1803F. The last packet, Packet ID # “Z” 1812F may be used by the memory address register to clear up the corresponding location in memory sub-block. Similarly, other packets in FIFO buffer that have been processed may be cleared up one by one. According to one embodiment, a memory address register 1805F receives 1801F a packet ID number, e.g., “A”, from a FIFO buffer 1803F. The memory address register 1805F may identify a corresponding packet ID address 1807F. For example, the memory address register 1805F may identify a sub-block, e.g., sub-block m, within 1-N sub-blocks. Accordingly, in response to its access, e.g., accessing packet ID address 1807F, the memory location that corresponds to packet ID address 1807F may be cleared. As such, the cleared location becomes available to new packet information. In one embodiment, clearing the share memory buffer may be performed at a predetermined time in order to allow the receipt of the confirmation packet corresponding to packet associated with the information in the packet ID address of the involved sub-block (e.g., 1-N).

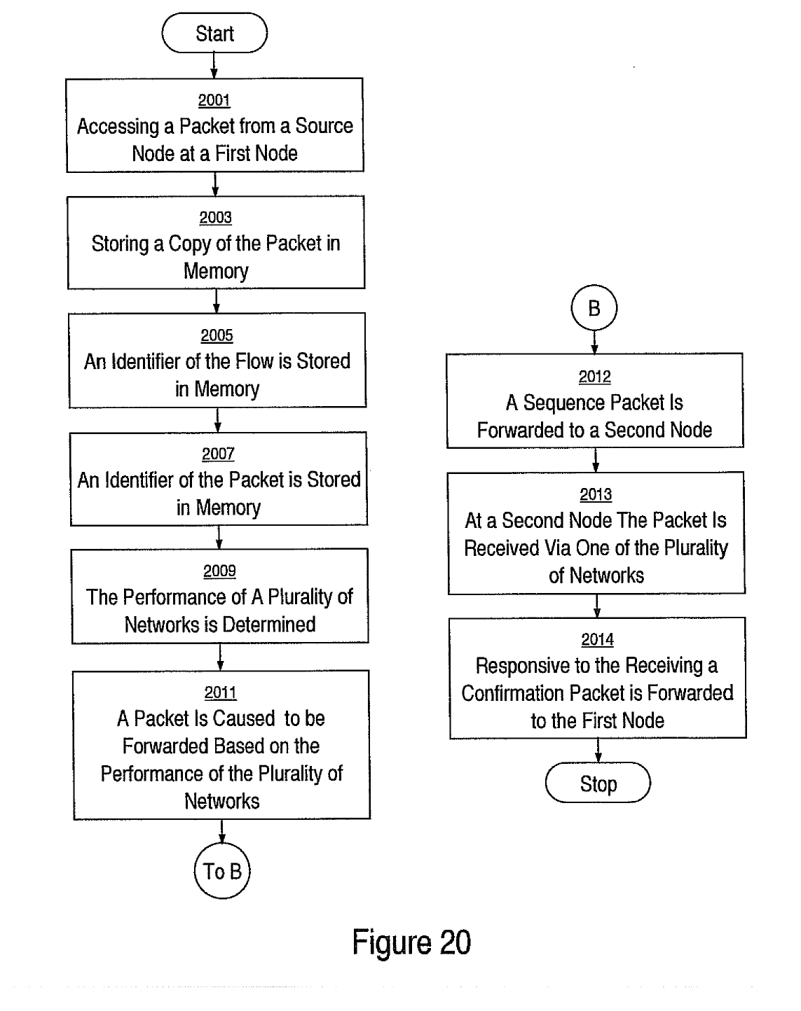

Referring now to FIG. 19, components of a system for management of packet flow in accordance with one embodiment of the present invention is shown. In one embodiment, a system 1900 implements an algorithm or algorithms that manage packet flow in a network. The system 1900 may include packet accessor 1901, packet storing component 1903, flow data storing component 1904, packet data storing component 1905, performance determiner 1907 and packet forwarder 1909.

It is appreciated that aforementioned components of system 1900 may be implemented in hardware or software or any combination thereof. In one embodiment, components and operations of system can be encompassed by components and operations of one or more computer programs (e.g. program on board a computer, server, or switch, etc.). In another embodiment, components and operations of system can be separate from the aforementioned one or more computer programs but can operate cooperatively with components and operations thereof.

The packet accessor 1901 may access one or more packets from a source node to be transmitted over network paths to a destination node. It is appreciated that the packet accessor 1901 may access one or more packets from a network to be transmitted over various network paths to a destination node.

According to one embodiment, the packet storing component 1903 may store a copy of the packets to be transmitted in a memory component. Storing the packets to be transmitted enables a dropped packet to be retransmitted without a need to access the server or the source node when retransmission of the dropped packet is requested. Since the packets out of sequence may be successfully reassembled, the dropped packets only are retransmitted whereas in the conventional method packets following the dropped packets are also retransmitted. Moreover, the packet storing component 1903 retransmitting the dropped packets lessens the burden on the server and/or source node to take further action.

The flow data storing component 1904 may store data related to packet flows of data. For example, flow data storing component 1904 may store an identifier of data flows of interest. For example, the flow data storing component 1904 may store data related to the delay, jitter and etc., that may be used in measuring various attributes of the network performance.

The packet data storing component 1905 may store data related to each packet that is transmitted. For example, the data related to each packet may be a signature or identifier of each of the packets that are a part of a given packet flow. Thus, the data related to each of the packets, e.g., signature, identifier, etc., may be used to distinguish a packet that belongs to a first packet flow from another packet that belongs to a second packet flow.

The performance determiner 1907 may determine the performance of network paths and compare the measure performance to threshold predetermined parameters. For example, the parameters for the performance may include packet loss, delay, jitter and out of sequence packets.

The packet forwarder 1909 may cause the packets to be transmitted to a packet destination node. In one embodiment, packet forwarder 1909 forwards packets over network paths to their destination node. It is appreciated that the packets being transmitted may be any packet, e.g., regular packets, confirmation packets, sequence packets, etc.

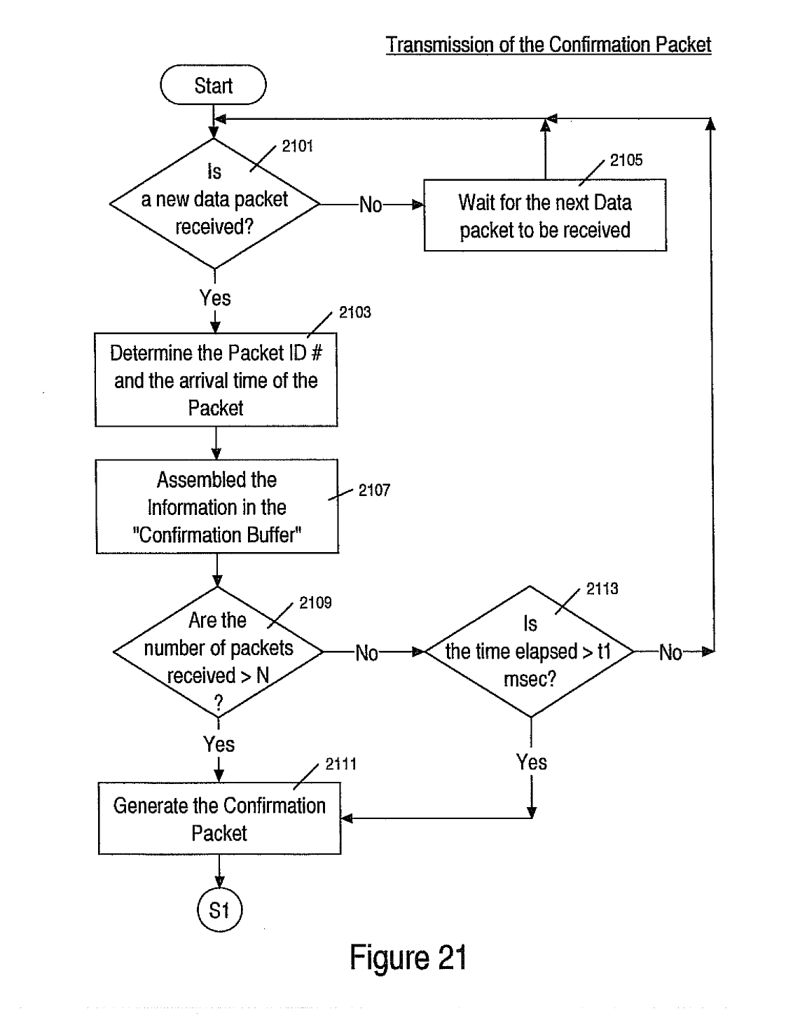

Referring now to FIG. 20, a method for management of packet flow in a network in accordance with one embodiment of the present invention is shown. The flowchart includes processes that, in one embodiment can be carried out by processors and electrical components under the control of computer-readable and computer-executable instructions. Although specific steps are disclosed in the flowcharts, such steps are exemplary. That is the present invention is well suited to performing various other steps or variations of the steps recited in the flowcharts. Within various embodiments, it should be appreciated that the steps of the flowcharts can be performed by software, by hardware or by a combination of both.

At step 2001, at a first transmitting node, one or more packets associated with a particular packet flow are accessed. The packets are accessed and received from a source node to be transmitted to a destination node via one or more network paths.

At step 2003, a copy of the packets to be transmitted may be stored in a memory component. Storing the packets to be transmitted enables a dropped packet to be retransmitted from the first transmitting node to the destination node without a need to access the server or the source node when retransmission of the dropped packet is requested. The dropped packets only are retransmitted because out of sequence packet may be successfully reassembled by a receiving component. In comparison, the conventional method requires packets following the dropped packets to be retransmitted as well since out of sequence packets cannot be reassembled under the conventional method. Moreover, retransmitting the stored copy of the dropped packets only lessens the burden on the server and/or source node to take further action.

At step 2005, an identifier of the packet flow that the packet belongs to may be stored in a memory component. For example, an identifier that detects that a packet belongs to flow A versus flow B may be stored. Accordingly, data related to a particular packet flow as identified by the identifier may be stored and used to ascertain various performance parameters of a network.

At step 2007, an identifier of the stored packet to be transmitted is stored in a memory component. In one embodiment, the identifier is a signature that can be used to distinguish one packet that is a part of the flow from another. For example, the signature may be used to detect that a packet belongs to packet flow A versus packet flow B.

At step 2009, the performance network paths may be determined. For example, the measured performance parameters for network paths may be compared to a threshold predetermined parameters. The parameters may include delay, packet drop rate, jitter and out of sequence packets, to name a few.

At step 2011a packet is transmitted via one or more of the plurality of network paths to the destination node. In one embodiment, the network path that is selected for forwarding the packet is selected based on the measured performance, e.g., delay, packet drop rate and/or jitter. At step 2012 a sequence packet may be transmitted to a second node in addition to the transmitted packets. In one embodiment, the sequence packet may provide information regarding the sequential ordering of the transmitted packets. Thus, received packets may be reassembled in the order transmitted instead of the order received.

It is appreciated that the protocols types that contain the sequence numbers within their fields, e.g., TCP, RTP, etc., may use these sequence numbers to properly re-order the packets based on different flow types. It is appreciated that the packet sequencer may also be used to re-sequence the packets transmitted.

At step 2013, at a second node, the packets are received via one of the plurality of network paths. The received packets may be stored in a memory component. The received packets are reassembled, as described above and a request for retransmission of dropped packets is transmitted to the first node. At step 2014, responsive to the receiving, a confirmation packet may be generated and transmitted to the first node to indicate that one or more packets have been received. The confirmation packet may identify various attributes in measuring the performance of network paths.

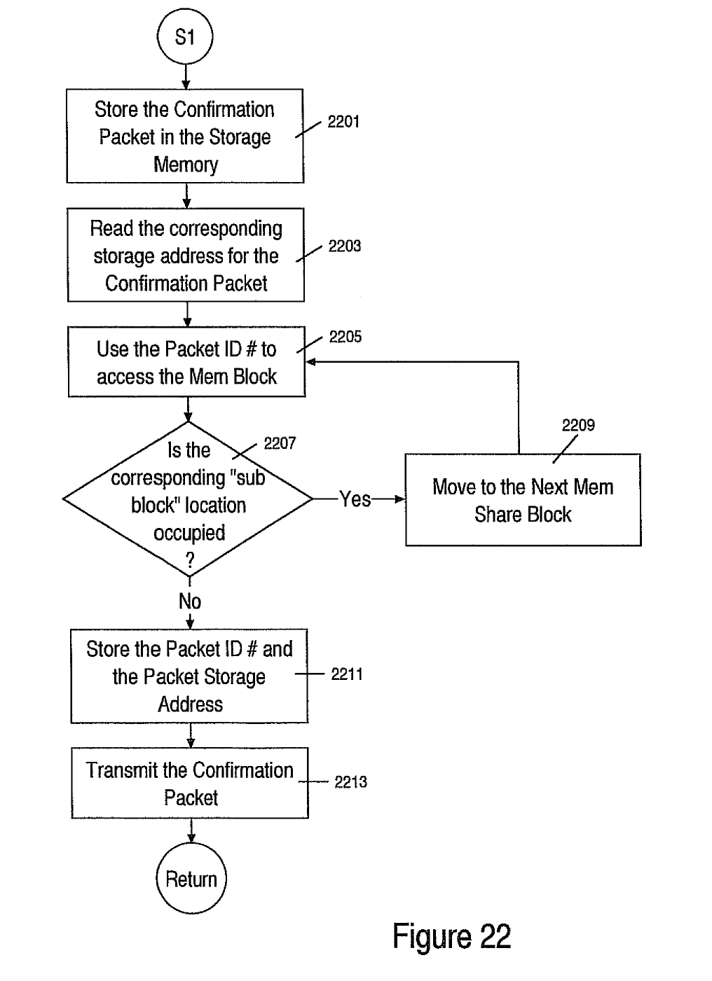

Referring now to FIG. 21, an exemplary method of transmitting a confirmation packet in accordance with one embodiment of the present invention is shown. In one embodiment, the aforementioned process implements the operation discussed with reference to step 2014 in the discussion of FIG. 20 above.

At step 2101, the standalone component at the second node may determine whether a new data packet has been received. If a new data packet has been received, at step 2103, the arrival time and packet ID of the data packet is determined. On the other hand, at step 2105 the standalone component may wait for the next data packet to be received if a new data packet has not been received.

At step 2107, the information in the confirmation buffer may be determined. At step 2109, the standalone component may determine whether the number of packets received is greater than N. It is appreciated that N may be any number and may be defined by a network administrator. At step 2111, the confirmation packet is generated if it is determined that the number of packets received is greater than N. However, at step 2113, if it is determined that the number of packets received is not greater than N, it is determined whether the elapsed time is greater than a predetermined amount of time. The predetermined amount of time may be user selectable, e.g., selected by the network administrator.

At step 2111, the confirmation packet may be generated if the elapsed time is greater than the predetermined amount of time. However, at step 2101 the standalone component checks to determine whether a new packet has been received if it is determined that the elapsed time is less than the predetermined amount of time.

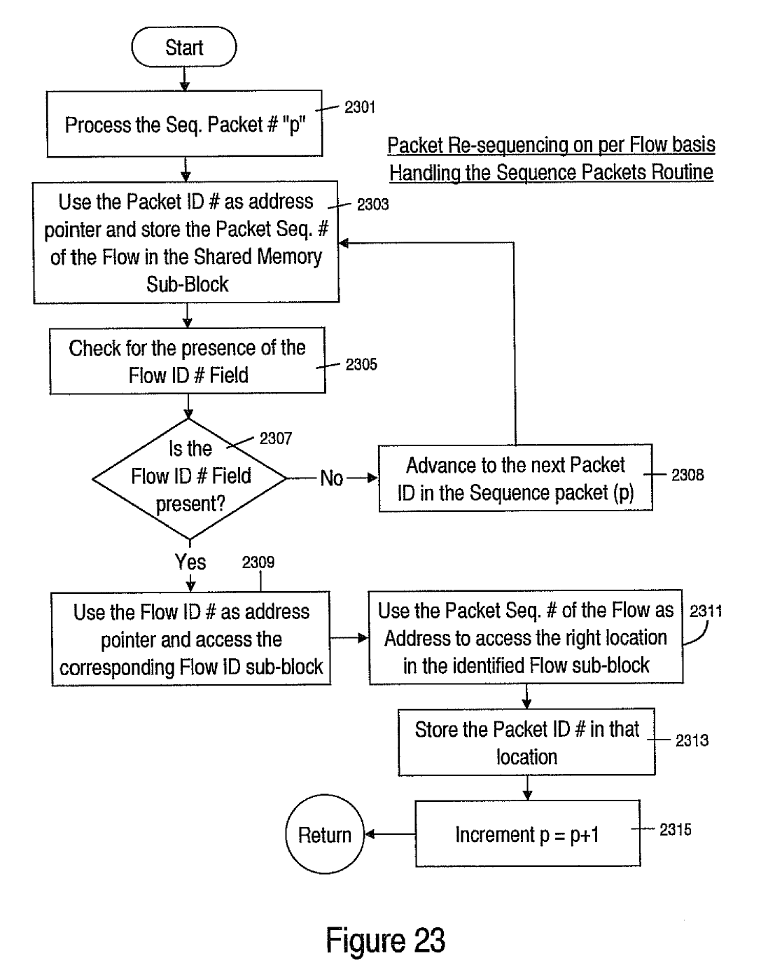

Referring now to FIG. 22, a continuation of the exemplary method of FIG. 21 is shown. At step 2201, the generated confirmation packet may be stored in a memory component. At step 2203, the corresponding storage address for the confirmation packet is read. At step 2205, the packet ID is used to access the memory block. At step 2207, it is determined whether the corresponding sub-block location is occupied.

If the corresponding sub-block location is occupied, then at step 2209, the control moves to the next memory share block and thereafter back to step 2205 for using the packet ID number to access the next block. At step 2207, if it is determined that the corresponding sub-block location is not occupied, then at step 2211 the packet storage address and ID number are stored. At step 2213, the confirmation packet is transmitted.

Referring now to FIG. 23, an exemplary method of packet re-sequencing on a per flow basis for handling the sequence packets routine in accordance with one embodiment of the present invention is shown. At step 2301, the sequence packet number, e.g. packet number p, is processed. At step 2303, the packet ID number is used as an address pointer to store the flow packet sequence number. For example, the packet ID number may be used to store the flow packet sequence number in a corresponding location of the shared memory sub-block.

At step 2305, presence of the flow ID number is checked. If the flow ID field is present, then at step 2309, the flow ID number is used as an address pointer to access the appropriate flow sub-block. However, if the flow ID field is not present, then at step 2308, the next packet ID in the sequence packet is advanced and thereafter proceeds to step 2303, as described above.

At step 2311, the flow sequence number is used as an address pointer to access the corresponding location within the flow sub-block. At step 2313, the packet ID number may be stored in the corresponding location that is accessed. As such, a step 2315, the sequence packet number p for the sub-block is incremented, e.g. p=p+1.

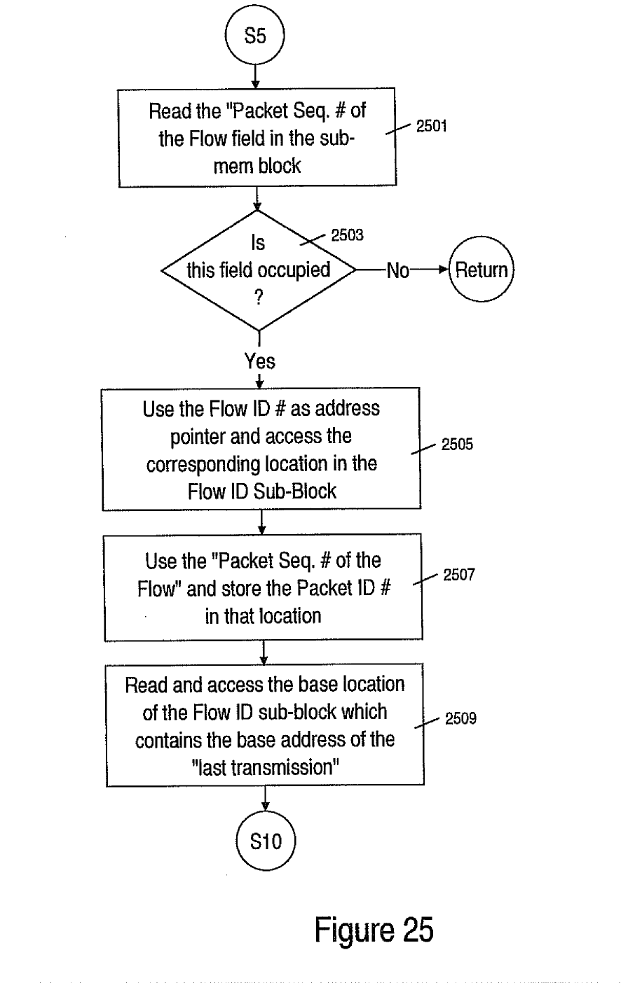

Referring now to FIG. 24, an exemplary method of packet re-sequencing on a per flow basis for handling data packets in accordance with one embodiment of the present invention is shown. At step 2401, it is determined whether a new data packet is received. If it is determined that a new data packet has not been received then the process returns to step 2401.

At step 2403, the data packet is stored in the packet storage area and the packet storage address is identified if it is determined that a new data packet has been received. At step 2405, the packet ID may be used to access a corresponding shared memory sub-block and to store the packet storage address. At step 2407, the flow ID of the received data packet may be classified. The flow ID number of the packet may be classified using any field embedded within the packet. It is appreciated that the transmitting side and the receiving side use the same fields embedded within the packet. As a result, the same packet flow ID is identified on the transmitting end and the receiving end. At step 2409, the packet ID number may be used as an address pointer to store the flow ID number in the corresponding shared memory sub-block.

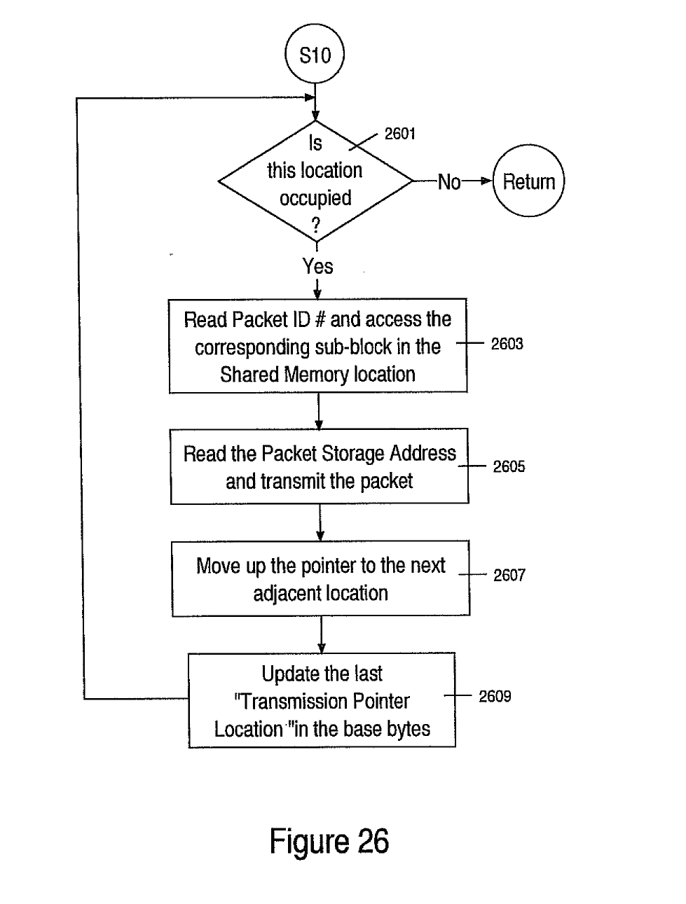

Referring now to FIG. 25, a continuation of the exemplary method of FIG. 24 is shown. At step 2501, the packet sequence number of the flow field of the sub-memory block is read. At step 2503, it is determined whether the flow field is occupied. The sequence packet containing the relative sequence number of the packet in the packet flow has not been received if it is determined that the flow field is not occupied. In other words if the sequence packet is not received then the packet ID number is used to identify the sub-block and the relative sequence number of the packet belonging to identified flow. The relative position of the received data packet in the flow number is not identified when this field is vacant. Accordingly, the next packet may be processed.

The sequence packet containing the relative sequence number of data packet within a flow ID is received and properly processed if it is determined that the flow field is occupied, at step 2505. Thus, the relative position of the new received data packet may be identified. If the received data packet has the next sequence number within the same flow ID number from the previously transmitted packet, then this packet should be transmitted as the next packet in the sequence. On the other hand, if the received packet does not have the next sequence number within the same flow ID number, then the received packet will not be transmitted.

At step 2507, the packet sequence number of the flow may be used to store the packet ID in that location. At step 2509, the base location of the flow ID sub-block is read and accessed. The address in the flow sub-block memory contains the pointer of the memory location accessed to transmit the packet. It is appreciated that each of the memory location in each of the flow sub-block may represent an incremental step in the sequence number for the transmission of the packet. The address is incremented to point to the adjacent location. If this location is occupied then it indicates that the new data packet that was received is the next data packet in the right sequence of the flow.

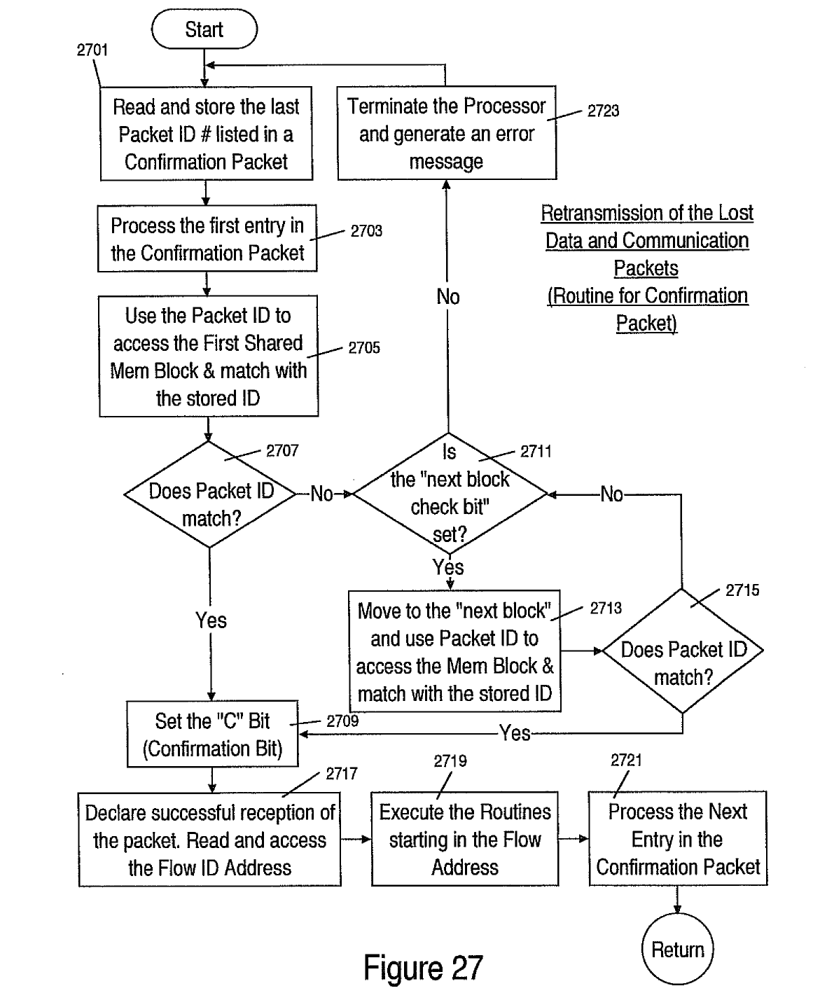

Referring now to FIG. 26, a continuation of the exemplary method of FIG. 25 is shown. At step 2601, it may be determined whether the base location of the flow ID sub-block is occupied. If it is determined that the location is not occupied, then step 2601 returns to the next data packet. However, if the location is occupied, at step 2603, the packet ID number may be used to access the corresponding sub-block in the shared memory location.

At step 2605, the packet storage address may be read and the packet may be transmitted. After successful transmission, the address is updated with the new pointer address referring to the new location as shown in step 2607. Thus, the pointer may be advanced to the next location. At step 2609, the last transmission pointer location in the base bytes is updated.

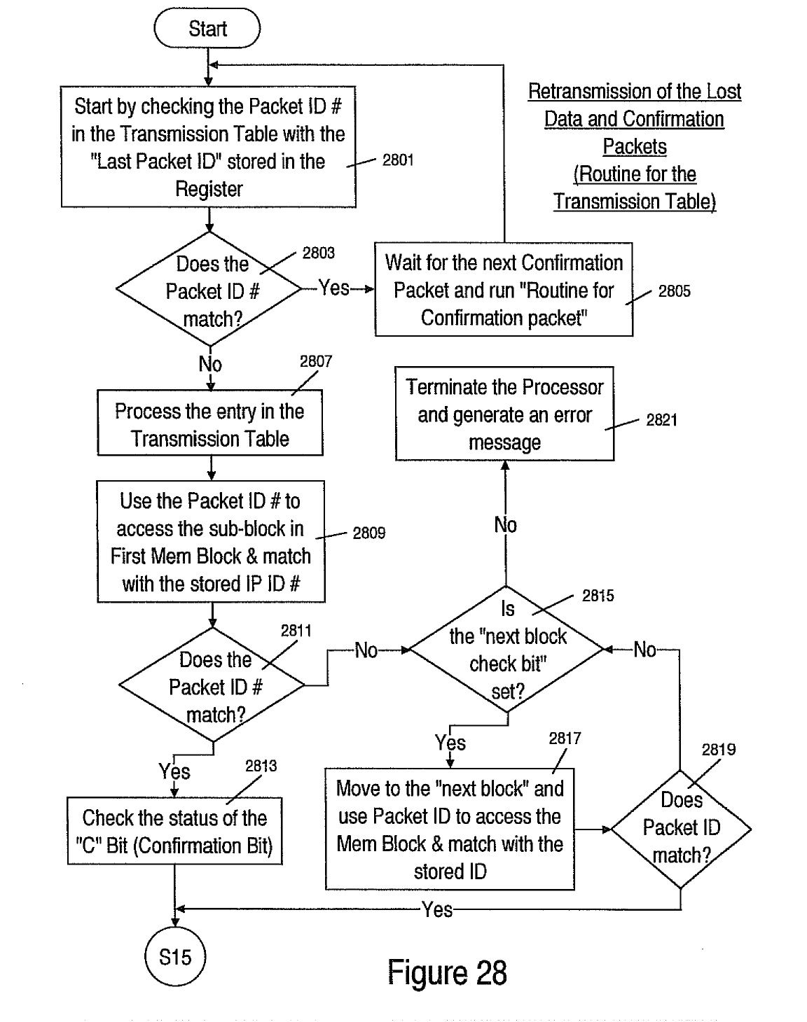

Referring now to FIG. 27, an exemplary method of retransmission of the lost packets based on confirmation packets in accordance with one embodiment of the present invention is shown. At step 2701, the last packet ID number listed in a confirmation packet is read and stored. At step 2703, the first entry in the confirmation packet is processed. At step 2705, the packet ID may be used to access the first shared memory block. Furthermore, at step 2705, the packet ID may be matched with the stored ID.

At step 2707, a determination is made whether the packet ID matches the stored ID. If the packet ID matches the stored ID then at step 2709 the C bit (confirmation bit) is set. At step 2717, successful reception of the packet is declared and the flow ID address is read and accessed. At step 2719, the routines starting in the flow address are executed. At step 2721, the next entry in the confirmation packet may be processed.

At step 2707, if it is determined that the packet ID does not match the stored ID, then at step 2711, it is determined whether the next block check bit is set. If the next block check bit is not set then at step 2723 the processor is terminated and an error message is generated. On the other hand, if the next block check bit is set then at step 2713 a move to the next block is advanced and the packet ID is used to access the memory block. Moreover, at step 2713, matching between the packet ID with the stored ID is performed. If the packet ID matches the stored ID at step 2715, then the confirmation bit is set at step 2709. On the other hand if the packet ID does not match the stored ID at step 2715, step 2711 is repeated.

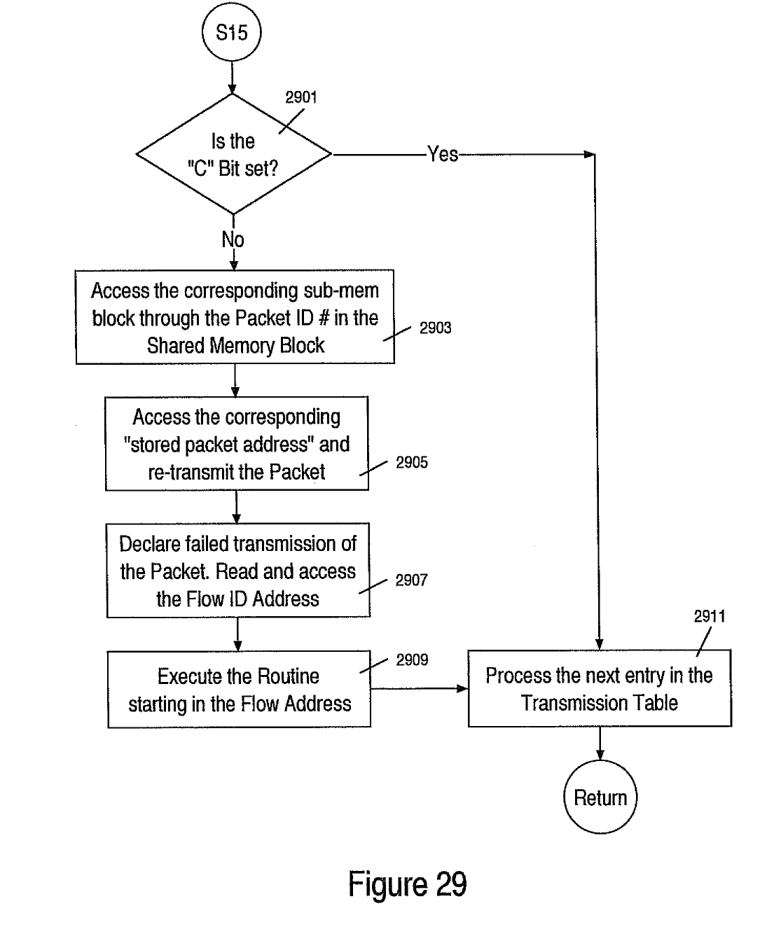

Referring now to FIG. 28, an exemplary method of retransmission of the lost packets based on transmission table according to one embodiment is shown. At step 2801, the packet ID number in the transmission table is compared with the last packet ID stored in the register. At step 2803, it is determined whether the packet number in the transmission table and the last packet ID stored in the register match.

If the packet number and the packet ID match, then at step 2805, the process waits for the next confirmation packet and the routine for the confirmation packet is executed. On the other hand, if there is a mismatch, at step 2807, the entry in the transmitted table is processed.

At step 2809, the packet ID may be used to access the sub-block in the first memory block. Moreover, at step 2809, the accessed sub-block in the first memory block is compared and matched with the stored IP ID number. At step 2811, it is determined whether the packet ID matches the stored IP ID.

If it is determined that the packet ID matches the stored ID, at step 2813, the status of the received bit C bit (confirmation bit) is checked. On the other hand, if it is determined that the packet ID number does not match the stored IP ID, at step 2815, the next block check bit status is checked. If it is determined that the next block check bit is set, at step 2817, the processor advances to the next block. Moreover, at step 2817, the packet ID may be used to access the memory block and to match it with the stored ID. At step 2819, it is determined whether the packet ID matches.

If the packet ID does not match at either step 2811 or at step 2819, then at step 2815, the next block status is checked. When the next block status is checked, the process advances to step 2817, otherwise the process advances to step 2821. At step 2821, the processor may be terminated and an error message may be generated.

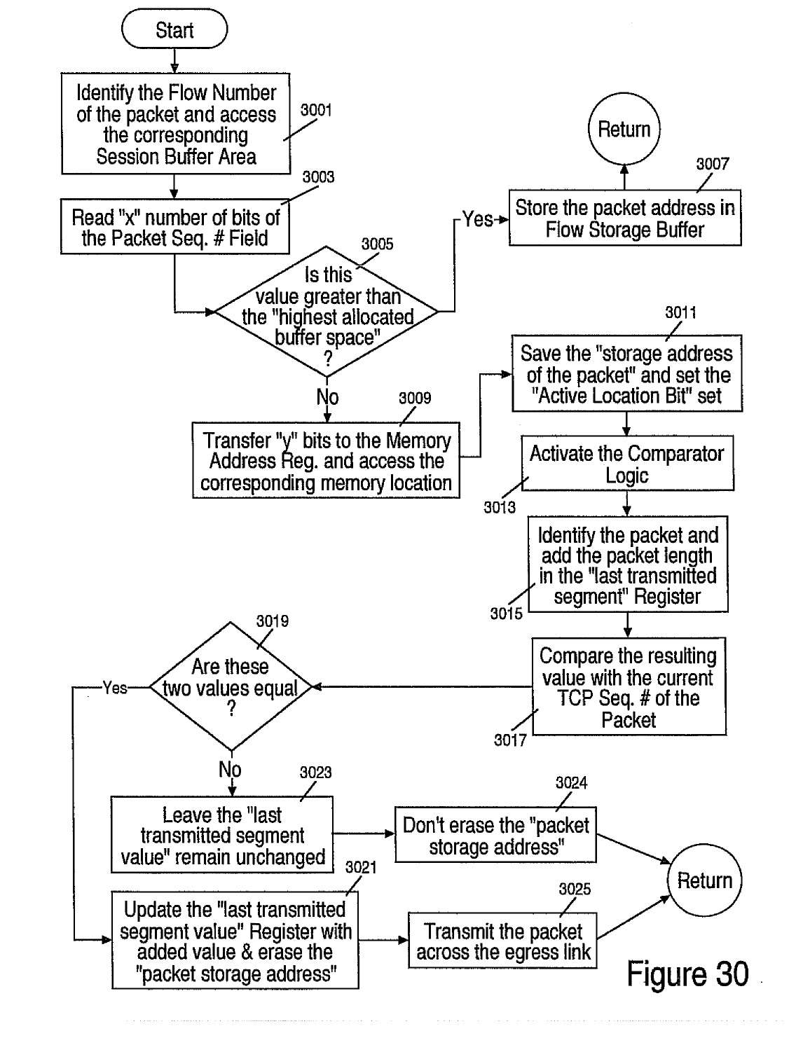

Referring now to FIG. 29, a continuation of the exemplary method of FIG. 28 is shown. After step 2813 or step 2819 if the packet ID matches, at step 2901 it is determined whether the C bit is set. At step 2901, if the C bit is set, then at step 2911 the next entry in the transmission table is processed.

On the other hand, if the C bit is not set, then at step 2903, the corresponding sub-block memory is accessed using the packet ID number in the shared memory block. At step 2905, the corresponding storage packet address is accessed and the packet may be retransmitted. At step 2907, the packet transmission is declared failed and the flow ID address is accessed and read. At step 2909, the routines starting in the flow address are executed.

Referring now to FIG. 30, an exemplary method of re-sequencing packets for transmission according to one embodiment of the present invention is shown. At step 3001, the flow number of the packet may be identified. Moreover, at step 3001, the corresponding session buffer area may be accessed accordingly. At step 3003, a number of bits, e.g., x bits, of the packet sequence number field are read. At step 3005, it is determined whether the number of bits of the packet sequence number field is greater than the highest allocated buffer space. If the value is greater than the highest allocated buffer space, then at step 3007, the packet address is stored in the flow storage buffer.

However, if the value is less than the highest allocated buffer space, then at step 3009, a number of bits, e.g., y bits, are transferred to the memory address register and the corresponding memory location is accessed. At step 3011, the storage address of the packet is stored and the active location bit is set. At step 3013, the comparator logic is activated. At step 3015, the packet is identified and the packet length is added to the last transmitted segment register. At step 3017, the resulting value is compared with the current TCP sequence number of the packet.

At step 3019, if it is determined the two values are equal, then at step 3021, the last transmitted segment value register is updated with added value and the packet storage address is erased. At step 3025, the packet may be transmitted across the egress link.

At step 3019, if it is determined that the two values are unequal, then at step 3023, the last transmitted segment value is left unchanged. At step 3024, the packet storage address is left unchanged and not erased.

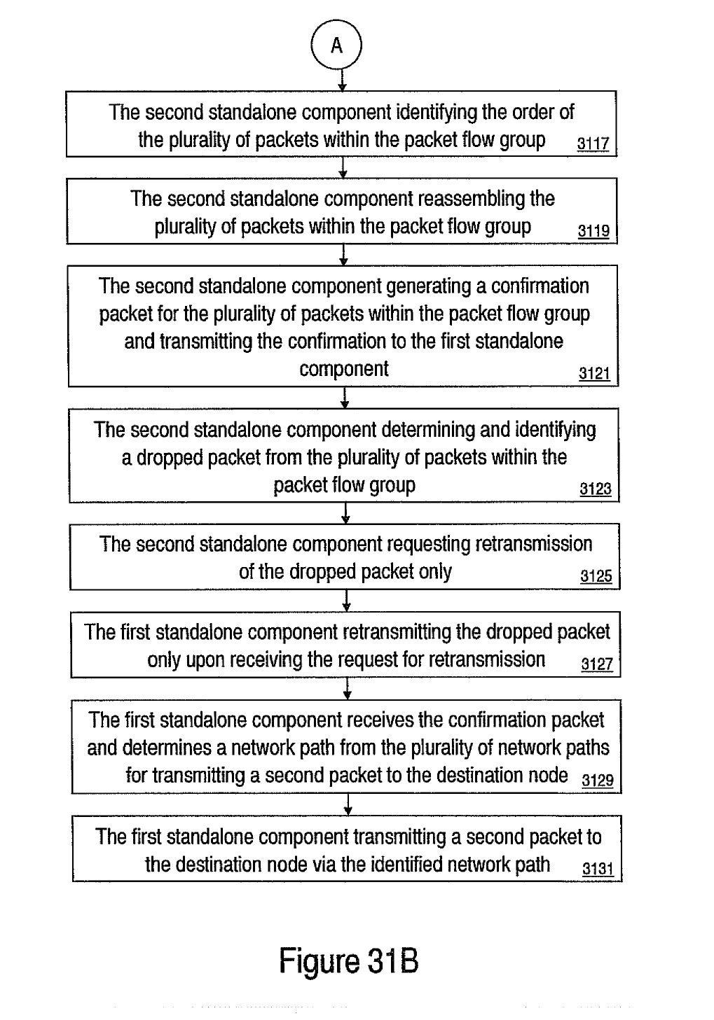

Referring now to FIGS. 31A and 31B, an exemplary method of managing packet flow in accordance with one embodiment of the present invention is shown. At step 3101, a first standalone component, e.g., 631D, receives a first packet or packets to be transmitted to a destination node. At step 3103, the first standalone component determines a packet flow group corresponding to the first packet. It is appreciated that the packet flow group may be any field or any portion of a field within a packet or any combination thereof. Moreover, it is appreciated that the packet flow group may be defined by a network administrator using a graphical user interface (GUI).

At step 3105, the first standalone component tracks the number of packets transmitted to the destination node that belong to the same packet flow group. According to one embodiment, the tracking is accomplished by setting a sequence number within the very first transmitted packet that is part of the same packet flow group. The sequence number for each subsequent packet to be transmitted that belongs to the same packet flow group is incremented. In another embodiment, a packet sequencer may be generated that includes information for enabling a second standalone component to reassemble the transmitted packets independent from the order of the received packets. The packet sequencer may be transmitted to the second standalone component.

At step 3107, a copy of the transmitted packets is stored in the first standalone component. At step 3109, the first standalone component transmits the first packet to the destination node via one or more of a plurality of network paths. At step 3111, the second standalone component receives a plurality of packets including the first packet. At step 3113, a copy of the received packets is stored by the second standalone component.

At step 3115, the second standalone component identifies the packet flow for each of the received packets, e.g., packet flow of the first packet. Hence, the packet flow, e.g., the packet flow group, that the first packet belongs to is identified. At step 3117, the second standalone component identifies the order of the plurality of packets within the packet flow group. In one embodiment, the ordering is achieved by using the packet sequencer sent by the first standalone component and received by the second standalone component. The ordering may also be achieved using the sequence number of the packets transmitted.

At step 3119, the second standalone component reassembles the plurality of packets within the packet flow group. It is appreciated that the reassembled plurality of packets may include the first packet transmitted by the first standalone component. At step 3121, the second standalone component generates a confirmation packet for the plurality of packets received within the packet flow group. The confirmation packet may include various performance attributes for a plurality of network paths, e.g., jitter, delay, out of sequence packets, dropped packets, etc. Furthermore, at step 3121, the confirmation packet is transmitted form the second standalone component to the first standalone component.

At step 3123, the second standalone component may identify whether a specific packet is dropped that belongs to a given packet flow group. It is appreciated that the identification of the specific packet that has been dropped may be based on the packet sequencer and/or the sequence number within each of the received packets. At step 3125, the second standalone component may request retransmission of the identified dropped packet only. Thus, packets following the dropped packet are not retransmitted, thereby reducing network congestion.

At step 3127, the first standalone component receives the request for the retransmission of the dropped packet and retransmits the identified dropped packet only. At step 3129, the first standalone component receives the confirmation packet and based on the confirmation packet determines a network path to be used in transmitting the next packet belonging to the packet flow group to the destination node. It is appreciated that the determining of the network path may be based on the defined packet flow group, the confirmation packet, e.g., measured performance of the network, and further based on the priorities of a packet flow as identified by the network administrator, e.g., predetermined acceptable threshold. At step 3131, the first standalone component transmits the next packet belonging to the packet flow group, e.g., second packet, to the destination node via the determined network path.

### Exemplary Hardware Operating Environment of System for Management of Packet Flow in a Network According to One Embodiment

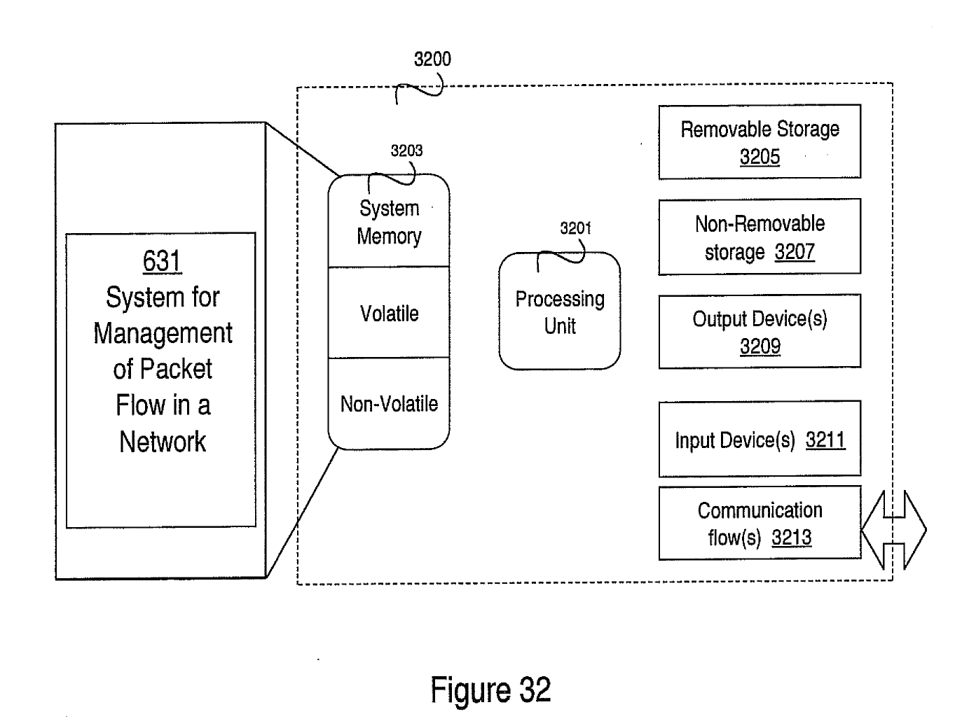

FIG. 32 shows an exemplary computing device 3200 according to one embodiment. Referring to FIG. 32, computing device 3200 can encompass a system 631D (or 633D in FIG. 6D) in accordance with one embodiment. Computing device 3200 typically includes at least some form of computer readable media. Computer readable media can be any available media that can be accessed by computing device 3200 and can include but is not limited to computer storage media.

In its most basic configuration, computing device 3200 typically includes processing unit 3201 and system memory 3203. Depending on the exact configuration and type of computing device 3200 that is used, system memory 3203 can include volatile (such as RAM) and non-volatile (such as ROM, flash memory, etc.) elements or some combination of the two. In one embodiment, as shown in FIG. 32, system 631D for management of packet flow in a network (see description of system 631D made with reference to FIG. 6D) can reside in system memory 3203.

Additionally, computing device 3200 can include mass storage systems (removable 3205 and/or non-removable 3207) such as magnetic or optical disks or tape. Similarly, computing device 3200 can include input devices 3211 and/or output devices 3209 (e.g., such as a display). Additionally, computing device 3200 can include network connections 3213 to other devices, computers, networks, servers, etc. using either wired or wireless media. As all of these devices are well known in the art, they need not be discussed in detail.

With reference to exemplary embodiments thereof, methods and systems for managing packet flow in a network are disclosed. The disclosed methodology involves accessing one or more packets that are to be forwarded over at least one of a plurality of networks to a destination node, storing a copy of the one or more packets, storing data related to the one or more packets and determining the performance of the plurality of networks as it relates to predetermined parameters. Based on the performance of the plurality of networks as it relates to the predetermined parameters the one or more packets are forwarded over one or more of the plurality of networks.

The foregoing descriptions of specific embodiments have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A standalone component method of managing packet flow in a network, said method comprising:
receiving a first packet for transmission to a destination node;
determining a packet flow group corresponding to said first packet;
tracking the number of packets transmitted to said destination node that belong to said packet flow group;
transmitting said first packet to said destination node via one of a plurality of network paths;
receiving a confirmation packet, wherein said confirmation packet comprises performance attributes of a plurality of network paths; and
in response to said confirmation packet, determining a network path from said plurality of network paths for transmitting a second packet to said destination node, wherein said second packet belongs to said packet flow group.

2. The method as described in claim 1, wherein said tracking comprises:
setting a sequence number for the very first packet of said packet flow group to be transmitted to said destination node; and
incrementing said sequence number for any subsequent packets of said packet flow group transmitted to said destination node.

3. The method as described in claim 1, wherein said tracking comprises:
generating a packet sequencer, wherein said packet sequencer comprises information operable to reassemble transmitted packets independent from the order received; and
transmitting said packet sequencer to said destination node for packets belonging to said packet flow group.

4. The method as described in claim 1, wherein said packet flow group is user defined.

5. The method as described in claim 1, wherein said packet flow group is defined based on any portion of a plurality of fields within a packet.

6. The method as described in claim 1, wherein said attributes of said plurality of network paths is selected from a group consisting of packet loss, jitter, out of sequence packets and delay.

7. The method as described in claim 1 further comprising:
storing a copy of said first packet in said standalone component prior to transmission thereof.

8. The method as described in claim 7 further comprising:
retransmitting said first packet from said standalone component upon receiving a request for retransmission of said first packet, wherein said retransmission eliminates retransmission of packets transmitted subsequent to said first packet.

9. The method as described in claim 1, wherein said determining said network path is based on a user defined priorities for said packet flow group and further based on a user defined predetermined acceptable threshold for performance of a network.

10. A method of reassembling out of sequence packets, said method comprising:
receiving a plurality of packets from a first standalone component;
storing said plurality of packets;
identifying a first group within said plurality of packets that belong to a packet flow group;
receiving a packet sequencer corresponding to said first group, wherein said packet sequencer comprises information regarding the number of packets within said first group transmitted, and wherein said packet sequencer further comprises information regarding the sequence of a plurality of packets within said first group;
in response to said packet sequencer, reassembling said plurality of packets within said first group;
generating a confirmation packet, wherein said confirmation comprises performance attributes of a plurality of network paths; and
transmitting said confirmation packet to said first standalone component.

11. The method as described in claim 10 further comprising:
based on said packet sequencer, determining whether a packet from said plurality of packets within said first group has been dropped; and
identifying said dropped packet.

12. The method as described in claim 11 further comprising:
sending a request for retransmission of said dropped packet to said first standalone component, wherein said request for retransmission eliminates retransmission of packets subsequent to said dropped packet.

13. The method as described in claim 10, wherein said packet flow group is user defined.

14. The method as described in claim 10, wherein said packet flow group is defined based on any portion of a plurality of fields within a packet.

15. The method as described in claim 10, wherein said attributes of said plurality of network paths is selected from a group consisting of packet loss, jitter, out of sequence packets and delay.

16. A method of reassembling out of sequence packets, said method comprising:
receiving a plurality of packets from a first standalone component;
storing said plurality of packets;
identifying a first group within said plurality of packets that belong to a packet flow group;
identifying an order of a plurality of packets within said first group, wherein said identifying is based on a sequence number of said plurality of packets within said first group;
in response to said identifying said order, reassembling said plurality of packets within said first group;
generating a confirmation packet, wherein said confirmation comprises performance attributes of a plurality of network paths for said plurality of packets within said first group; and
transmitting said confirmation packet to said first standalone component.

17. The method as described in claim 16, wherein said identifying said order of said plurality of packets within said first group comprises:
sequencing said plurality of packets within said first group based on a sequence number of said plurality of packets within said first group.

18. The method as described in claim 17 further comprising:
based on said sequencing, determining whether a packet from said plurality of packets within said first group has been dropped; and
identifying said dropped packet.

19. The method as described in claim 18 further comprising:
sending a request for retransmission of said dropped packet to said first standalone component, wherein said request for retransmission eliminates retransmission of packets subsequent to said dropped packet.

20. The method as described in claim 16, wherein said packet flow group is user defined.

21. The method as described in claim 16, wherein said packet flow group is defined based on any portion of a plurality of fields within a packet.

22. The method as described in claim 16, wherein said attributes of said plurality of network paths is selected from a group consisting of packet loss, jitter, out of sequence packets and delay.
